(19) United States
(12) Patent Application Publication
(10) Pub. No.: US 2021/0201616 A1
(43) Pub. Date: Jul. 1, 2021

(54) SHEET HANDLING APPARATUS

(71) Applicant: Glory Ltd., Himeji-shi (JP)

(72) Inventor: Takanori NAKAI, Himeji-shi (JP)

(73) Assignee: Glory Ltd., Himeji-shi (JP)

(21) Appl. No.: 17/131,836

(22) Filed: Dec. 23, 2020

(30) Foreign Application Priority Data
Dec. 27, 2019 (JP) 2019-237612

(51) Int. Cl. G07D 11/18; G07D 11/14; G07D 7/06; G07D 11/30

(52) U.S. Cl. CPC G07D 11/18; G07D 11/14; G07D 2211/00; G07D 11/30; G07D 2207/00; G07D 7/06

(57) ABSTRACT

A sheet handling apparatus includes a transport path that includes a first path, a second path, and a curved portion connecting the first path and the second path, the transport path circularly transports a sheet along the transport path in a forward direction or a backward direction. The sheet handling apparatus further includes a rolling body that is disposed at the curved portion and rotates clockwise and counterclockwise, and a plurality of rollers that are opposed to the rolling body and sandwich the sheet between each of the plurality of rollers and the rolling body along the curved portion of the transport path. The rolling body transports the sheet in the forward direction by rotating clockwise and transports the sheet in the backward direction by rotating counterclockwise.

### CROSS-REFERENCE TO RELATED APPLICATION

This application claims priority to Japanese Patent Application No. 2019-237612 filed on Dec. 27, 2019, the entire disclosure of which is incorporated herein by reference.

### BACKGROUND

Conventionally, a sheet handling apparatus includes an endless loop transport path provided inside a casing. Sheets are circulated both forward and backward along the loop transport path. The loop transport path is comprised of a combination of a large number of rollers, a plurality of belts, and a plurality of guides. In the conventional device, the loop transport path includes a first path, a second path parallel to the first path, and two curved portions connecting the first path and the second path. Each of the curved portions includes a circumferential transport path.

In a known curved portion, the circumferential transport path is comprised of the plurality of roller pairs and the plurality of guides. The curved portions include a large number of parts. Further, in the known curved portion, the roller pairs and the fixed guides are arranged alternately along the transport path. For this reason, a sheet easily gets caught, thus causing a jam.

### SUMMARY

A first aspect of the present disclosure relates to a sheet handling apparatus that includes a first path, a second path, and a curved portion connecting the first path and the second path, the transport path circularly transports a sheet along the transport path in a forward direction or a backward direction. The sheet handling apparatus further includes a rolling body that is disposed at the curved portion and rotates clockwise and counterclockwise, and a plurality of rollers that are opposed to the rolling body and sandwich the sheet between each of the plurality of rollers and the rolling body along the curved portion of the transport path. The rolling body transports the sheet in the forward direction by rotating clockwise and transports the sheet in the backward direction by rotating counterclockwise.

### BRIEF DESCRIPTION OF THE DRAWINGS

FIG. 1 is a perspective view illustrating an external appearance of a banknote handling apparatus.

FIG. 2 is a diagram illustrating an internal configuration of the banknote handling apparatus.

FIG. 3 is a block diagram illustrating a configuration of the banknote handling apparatus.

FIG. 4 is a diagram illustrating a state in which a storing unit is taken out from the banknote handling apparatus.

FIG. 5 illustrates a first variation of the banknote handling apparatus.

FIG. 6 is a diagram illustrating a configuration of an upper transport unit of the banknote handling apparatus, in an enlarged scale.

FIG. 7 is a diagram illustrating a configuration of a front curved portion in an enlarged scale.

FIG. 8 illustrates a variation of the front curved portion.

FIG. 9 is a flowchart of control relating to a sensor cleaning alarm.

FIG. 10 is a perspective view illustrating a lamp indicating an installation state of the storing unit.

FIG. 11 consists of an upper drawing that is a plan view of a connector, and a lower drawing that is a side view of the connector.

FIG. 12 is an enlarged view of the connector.

FIG. 13 is a side view illustrating a lamp indicating a state of occupation of the banknote handling apparatus.

FIG. 14 consists of an upper drawing that is a plan view of a depositing unit and a dispensing unit, and a lower drawing that is a cross-sectional view taken along the line A-A.

FIG. 15 consists of an upper drawing illustrating feed rollers of the depositing unit feeding a first banknote, and a lower drawing illustrating the feed rollers after the first banknote has been fed.

FIG. 16 is a perspective view of first, second and third example configurations of the feed roller.

FIG. 17 is an exploded perspective view of the first example configuration of the feed roller.

FIG. 18 is an exploded perspective view of the second example configuration of the feed roller.

FIG. 19 is an exploded perspective view of the third example configuration of the feed roller.

FIG. 20 is a diagram illustrating an internal configuration of a compact storing unit.

FIG. 21 is a perspective view illustrating a configuration of a guide of the compact storing unit.

FIG. 22 is a cross-sectional view taken along the line B-B in FIG. 21.

FIG. 23 is a diagram illustrating a mode shift of the banknote handling apparatus.

FIG. 24 is a diagram illustrating an energization state of each component when the apparatus is in a power-off mode, a sleep mode, and an eco-mode.

FIG. 25 illustrates a second variation of the banknote handling apparatus.

FIG. 26 illustrates a third variation of the banknote handling apparatus.

FIG. 27 is a diagram of programmable circuitry in the form of a computer configured to implement the control operations described herein.

### DETAILED DESCRIPTION OF THE DRAWINGS

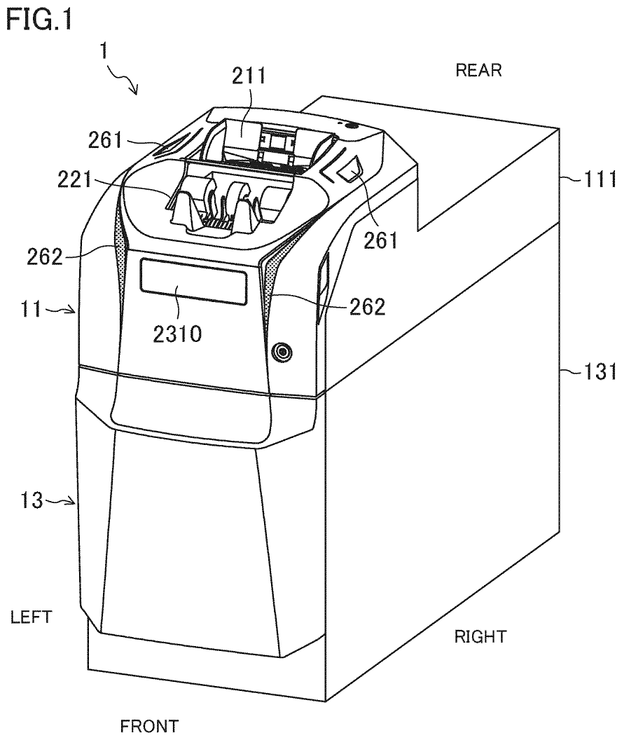

An embodiment of a sheet handling apparatus will be described in detail below with reference to the drawings. The sheet handling apparatus described herein is an example. FIG. 1 illustrates an external appearance of a banknote handling apparatus 1 as the sheet handling apparatus. The banknote handling apparatus 1 is installed in, for example, a financial institution such as a bank. The banknote handling apparatus 1 is installed in, for example, a teller counter in a bank. The banknote handling apparatus 1 performs various processes including a depositing process and a dispensing process.

The banknote handling apparatus 1 has an elongated shape in a front-rear direction. A front of the banknote handling apparatus 1 refers to a portion where an inlet 211 and an outlet 221, which will be described later, are formed. A rear of the banknote handling apparatus 1 refers to a portion opposite to the portion where the inlet 211 and the outlet 221 are formed.

The banknote handling apparatus 1 may be shared by two tellers. The two tellers may be positioned on both right and left sides of the banknote handling apparatus 1. The teller who wants to use the banknote handling apparatus 1 operates an occupation switch 261 that will be described later. Note that a right-left direction of the banknote handling apparatus 1 is a direction orthogonal to the front-rear direction.

The banknote handling apparatus 1 may be installed in, for example, a back office of a retail store, in addition to a financial institution.

(General Configuration of Banknote Handling Apparatus)

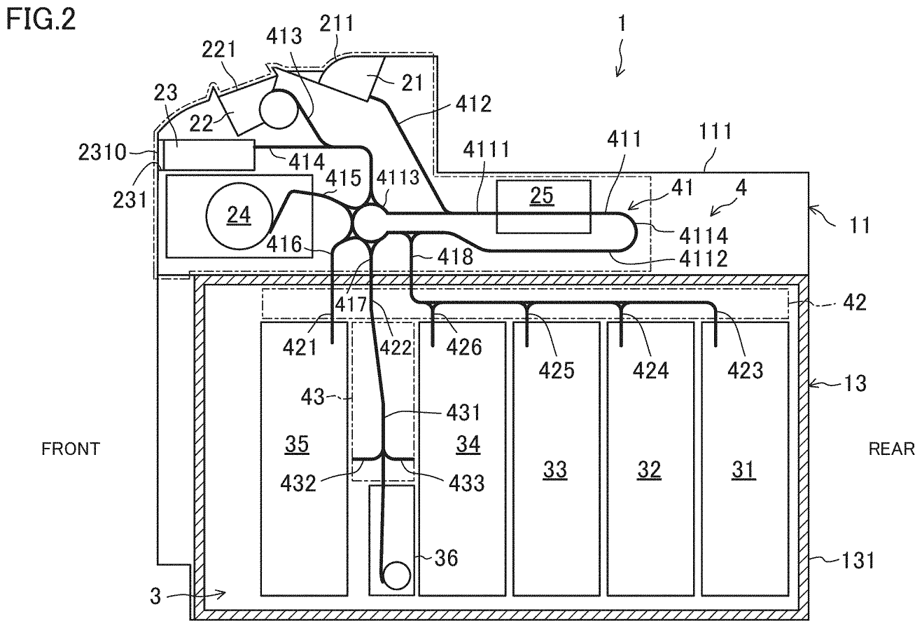

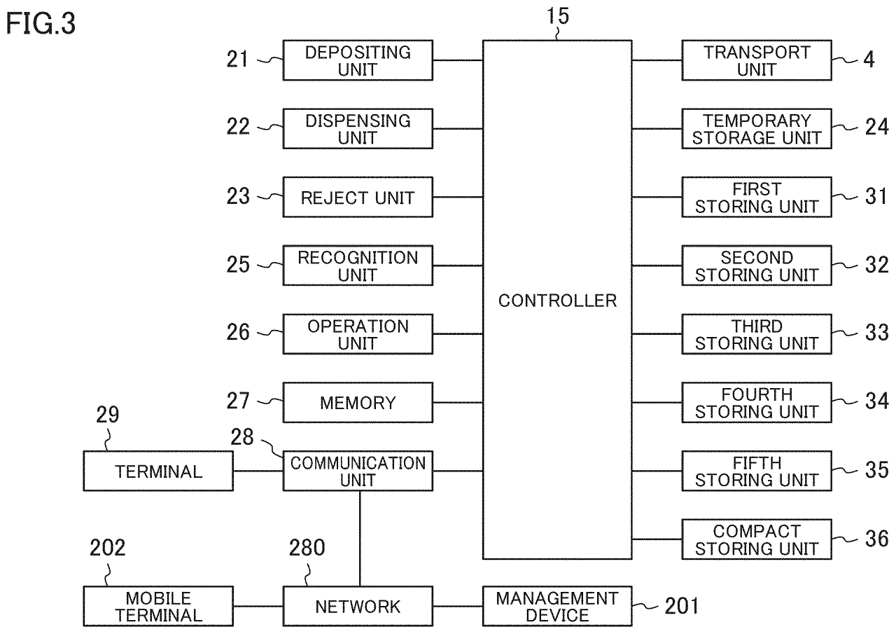

FIG. 2 is a schematic view of an internal configuration of the banknote handling apparatus 1. FIG. 3 is a block diagram illustrating a configuration of the banknote handling apparatus 1. The banknote handling apparatus 1 handles loose notes. The banknote handling apparatus 1 includes an upper handling unit 11 and a lower safe unit 13.

The handling unit 11 is comprised of an upper housing 111. In the upper housing 111, a depositing unit 21, a dispensing unit 22, a reject unit 23, a temporary storage unit 24, a recognition unit 25, and an upper transport unit 41 are disposed. The upper transport unit 41 is a part of a transport unit 4. An operator can draw the upper housing 111, that is, a portion surrounded by a dot-dash line in FIG. 2, out to the front. This drawable portion includes the depositing unit 21, the dispensing unit 22, the reject unit 23, the temporary storage unit 24, the recognition unit 25, and the upper transport unit 41.

The safe unit 13 is comprised of a safe housing 131. In the safe housing 131, a plurality of storing units 31 to 35, a compact storing unit 36, a lower transport unit 42, and a second lower transport unit 43 are disposed. The lower transport unit 42 and the second lower transport unit 43 are a part of the transport unit 4. The safe housing 131 protects the storing units 31 to 35 and 36 at a security level equal to or higher than a predetermined level. Specifically, the safe housing 131 is comprised of a metal board of a thickness equal to or higher than a predetermined thickness. The security level of the safe housing 131 is higher than that of the upper housing 111.

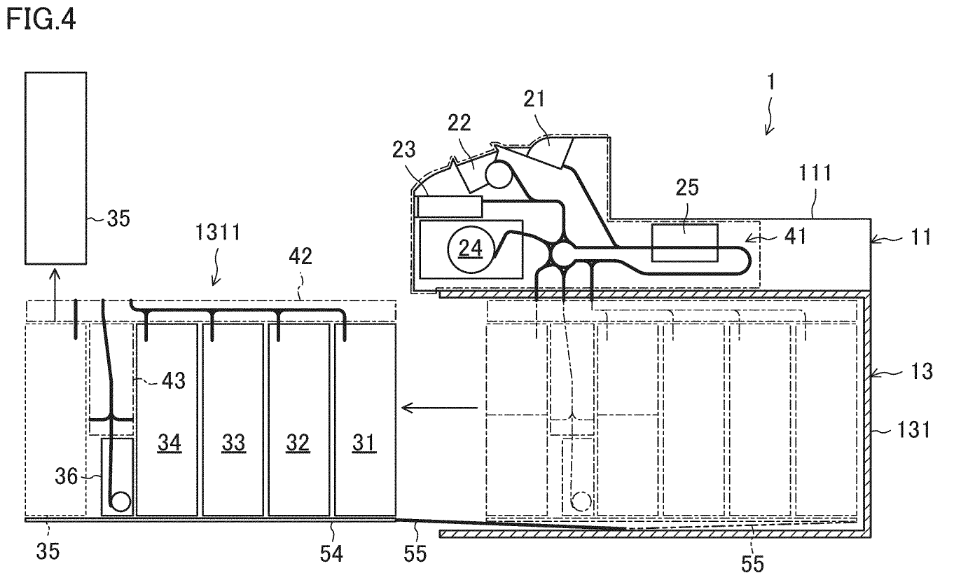

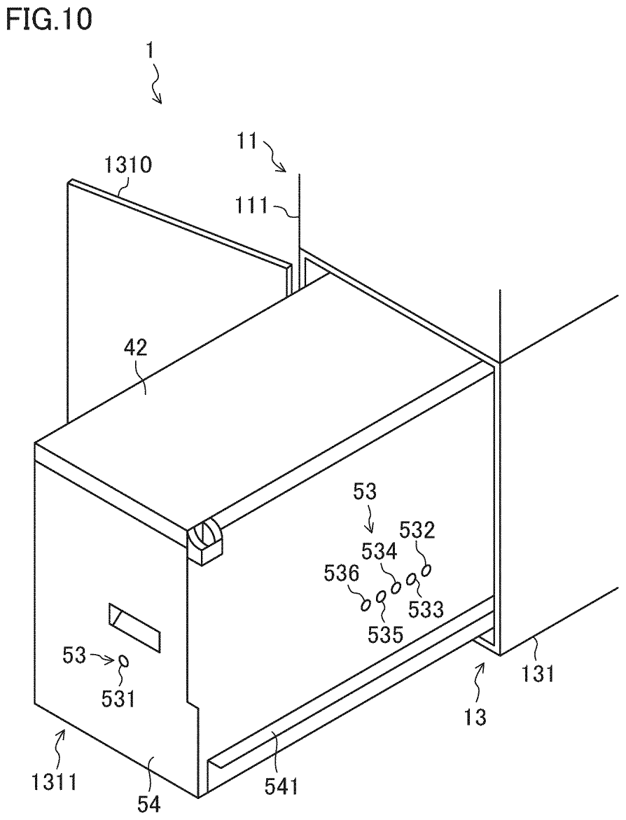

The safe housing 131 has a door 1310 on its front portion (see FIG. 10). As shown in FIG. 4, when the operator opens the door 1310, the operator can draw out to the front the storing units 31 to 35, the compact storing unit 36, the lower transport unit 42, and the second lower transport unit 43 from the safe housing 131. The door 1310 may be provided with an electronic lock. When the operator unlocks the electronic lock, the door 1310 opens.

The depositing unit 21 is a portion of the apparatus into which the banknotes to be deposited are inserted, for example, in a depositing process. The depositing unit 21 has an inlet 211. The inlet 211 opens upward at a front portion of the upper housing 111. The operator manually inserts the banknotes into the depositing unit 21 through the inlet 211. The depositing unit 21 is capable of holding a plurality of banknotes while the banknotes are stacked. The depositing unit 21 has a mechanism that takes the banknotes one by one into the banknote handling apparatus 1.

The dispensing unit 22 is a portion of the apparatus to which banknotes fed from the storing unit are transported, for example, in a dispensing process. The dispensing unit 22 is capable of holding a plurality of banknotes while the banknotes are stacked. The dispensing unit 22 has an outlet 221. The outlet 221 opens upward at a position closer to the front than the inlet 211. The operator can manually remove the banknotes stacked in the dispensing unit 22 through the outlet 221. The outlet 221 may be provided with a shutter which opens and closes.

The reject unit 23 is a portion of the apparatus to which banknotes rejected, for example, in a depositing process, are transported. The reject unit 23 is disposed in the front portion of the upper housing 111. The reject unit 23 is configured to hold a plurality of banknotes while the banknotes are stacked. The reject unit 23 has a second outlet 231. The second outlet 231 opens frontward at a front portion of the upper housing 111. The second outlet 231 is provided with a shutter 2310. The shutter 2310 is provided at a front surface of the upper housing 111, as shown in FIG. 1. When the shutter 2310 opens, the operator can remove the banknotes stacked in the reject unit 23 through the second outlet 231.

The temporary storage unit 24 temporarily stores the banknotes to be deposited, for example, in the depositing process. The temporary storage unit 24 can feed the stored banknotes. The temporary storage unit 24 is arranged at a front position in the upper housing 111. The temporary storage unit 24 is disposed under the reject unit 23. The temporary storage unit 24 is a tape-winding storing unit. The temporary storage unit 24 stores the banknotes by wrapping them around a drum together with a tape. The tape-winding storing unit is advantageous because the order of banknotes does not change when the banknotes are stored and fed. Further, the tape-winding storing unit is also advantageous because it is capable of storing mixed banknotes of various sizes. A known configuration of the tape-winding storing unit may be employed as the temporary storage unit 24.

The recognition unit 25 is disposed in a first transport path 411 that will be described later. In some implementations, the recognition unit 23 is an imaging device, such as a camera or sensor. The recognition unit 25 recognizes at least whether each banknote being transported through the first transport path 411 is authentic or not, a denomination of each banknote, or whether each banknote is fit or unfit. The recognition unit 25 further acquires a serial number of each of the banknotes.

The banknote handling apparatus 1 includes a first storing unit 31, a second storing unit 32, a third storing unit 33, a fourth storing unit 34, and a fifth storing unit 35. The first storing unit 31, the second storing unit 32, the third storing unit 33, the fourth storing unit 34, and the fifth storing unit 35 are aligned in the front-rear direction inside the safe housing 131. The storing units 31 to 35 and a compact storing unit 36, which will be described later, constitute a storage section 3.

The first to fifth storing units 31 to 35 have the same configuration. These storing units 31 to 35 may be stacking storing units. The stacking storing unit stores banknotes by stacking them. Each of the first to fifth storing units 31 to 35 has one storage. In some implementations, each of the first to fifth storing units 31 to 35 further includes a transport mechanism. The transport mechanism inserts the banknotes from the outside to the inside of the storing unit and stores the banknotes in the storage. The transport mechanism further dispenses the banknotes stored in the storage from the inside to the outside of the storing unit.

The first storing unit 31, the second storing unit 32, the third storing unit 33, and the fourth storing unit 34 store the banknotes of different denominations. The fifth storing unit 35 stores the banknotes that are not stored in the first storing unit 31, the second storing unit 32, the third storing unit 33, and the fourth storing unit 34. The fifth storing unit 35 may also store the banknotes to be collected from the banknote handling apparatus 1.

The compact storing unit 36 is disposed between the fourth storing unit 34 and the fifth storing unit 35. The compact storing unit 36 is disposed under the second lower transport unit 43 that will be described later. The compact storing unit 36 is a tape-winding storing unit. The configuration of the compact storing unit 36 will be described in detail later.

The capacity of the compact storing unit 36 is smaller than the capacity of the first to fifth storing units 31 to 35. The capacity of the compact storing unit 36 may be, for example, around 100 banknotes. The compact storing unit 36 may be used for various purposes. For example, the compact storing unit 36 may store counterfeit notes or banknotes that are suspected to be counterfeit notes.

The transport unit 4 transports the banknotes one by one at intervals in the banknote handling apparatus 1. The transport unit 4 has a transport path. The transport path is comprised of a combination of a large number of rollers, a plurality of belts, a motor for driving the rollers, and a plurality of guides. The transport unit 4 transports the banknotes, for example, with their long edges facing forward. The transport unit 4 may transport the banknotes with their short edges facing forward.

The transport unit 4 includes the upper transport unit 41, the lower transport unit 42, and the second lower transport unit 43. The upper transport unit 41 is arranged in the upper housing 111, as mentioned above. The lower transport unit 42 and the second lower transport unit 43 are arranged in the safe housing 131. Note that three transport paths pass through an upper wall defining the safe housing 131 in the up-and-down direction. The three transport paths are aligned in the front-rear direction. The three transport paths connect, respectively, a sixth transport path 416 with a ninth transport path 421, a seventh transport path 417 with a tenth transport path 422, and an eighth transport path 418 with an eleventh transport path 423, which will be described later.

The upper transport unit 41 includes the first transport path 411, a second transport path 412, a third transport path 413, a fourth transport path 414, a fifth transport path 415, the sixth transport path 416, the seventh transport path 417, and the eighth transport path 418. The first transport path 411 corresponds to a circulation path. The third transport path 413, the fourth transport path 414, the fifth transport path 415, the sixth transport path 416, and the seventh transport path 417 correspond to a first branch. The eighth transport path 418 corresponds to a second branch.

The first transport path 411 is looped. More specifically, the first transport path 411 includes an upper path 4111 extending in the front-rear direction, a lower path 4112 approximately parallel to the upper path 4111, a front curved portion 4113 connecting the upper path 4111 and the lower path 4112 on the front side, and a rear curved portion 4114 connecting the upper path 4111 and the lower path 4112 on the rear side. The recognition unit 25 is disposed in the upper path 4111. The upper path 4111 is an example of a first path. The lower path 4112 is an example of a second path. Each of the front curved portion 4113 and the rear curved portion 4114 is an example of a curved portion. The configuration of the front curved portion 4113 will be described in detail later.

The transport unit 4 transports the banknotes along the first transport path 411 in a clockwise direction (i.e., forward) and the counterclockwise direction (i.e., backward) in FIG. 1. The first transport path 411 circulates the banknotes.

The second transport path 412 connects the depositing unit 21 and the upper path 4111 of the first transport path 411 with each other. The second transport path 412 transports the banknotes from the depositing unit 21 toward the first transport path 411.

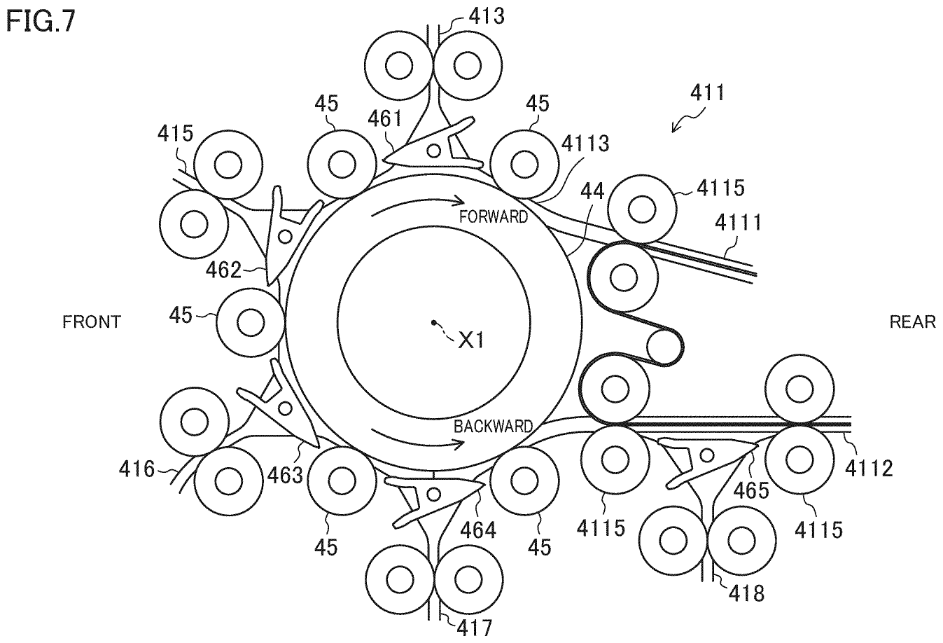

The third transport path 413 connects the dispensing unit 22 and the front curved portion 4113 of the first transport path 411 with each other. The third transport path 413 transports the banknotes from the first transport path 411 toward the dispensing unit 22. In some implementations, a junction between the third transport path 413 and the front curved portion 4113 is provided with a diverter 461 (see FIG. 7) for changing the destination of the banknotes.

The fourth transport path 414 connects the reject unit 23 and an intermediate location of the third transport path 413 with each other. The fourth transport path 414 transports the banknotes from the third transport path 413 toward the reject unit 23. A junction between the fourth transport path 414 and the third transport path 413 is provided with a diverter.

The fifth transport path 415 connects the temporary storage unit 24 and the front curved portion 4113 of the first transport path 411 with each other. The fifth transport path 415 transports the banknotes from the first transport path 411 toward the temporary storage unit 24 and from the temporary storage unit 24 toward the first transport path 411. A junction between the fifth transport path 415 and the front curved portion 4113 is provided with a diverter 462.

The sixth transport path 416 connects the lower transport unit 42 and the front curved portion 4113 of the first transport path 411 with each other. The sixth transport path 416 transports the banknotes from the first transport path 411 toward the lower transport unit 42 and from the lower transport unit 42 toward the first transport path 411. A junction between the sixth transport path 416 and the front curved portion 4113 is provided with a diverter 463.

Similarly to the sixth transport path 416, the seventh transport path 417, too, connects the lower transport unit 42 and the front curved portion 4113 of the first transport path 411 with each other. The seventh transport path 417 transports the banknotes from the first transport path 411 toward the lower transport unit 42 and from the lower transport unit 42 toward the first transport path 411. A junction between the seventh transport path 417 and the front curved portion 4113 is provided with a diverter 464.

The eighth transport path 418 connects the lower transport unit 42 and the lower path 4112 of the first transport path 411 with each other. The eighth transport path 418 transports the banknotes from the first transport path 411 toward the lower transport unit 42 and from the lower transport unit 42 toward the first transport path 411. A junction between the eighth transport path 418 and the lower path 4112 is provided with a diverter 465.

The lower transport unit 42 is disposed above the first to fifth storing units 31 to 35. The lower transport unit 42 extends in the front-rear direction. The lower transport unit 42 includes the ninth transport path 421, the tenth transport path 422, and the eleventh transport path 423. The lower transport unit 42 is configured as one unit which includes the ninth transport path 421, the tenth transport path 422, and the eleventh transport path 423.

The ninth transport path 421 connects the fifth storing unit 35 and the sixth transport path 416 with each other. The ninth transport path 421 transports the banknotes from the sixth transport path 416 toward the fifth storing unit 35 and from the fifth storing unit 35 toward the sixth transport path 416.

The tenth transport path 422 connects the second lower transport unit 43 and the seventh transport path 417 with each other. The tenth transport path 422 transports the banknotes from the seventh transport path 417 toward the second lower transport unit 43 and from the second lower transport unit 43 toward the seventh transport path 417.

The eleventh transport path 423 connects each of the first storing unit 31, the second storing unit 32, the third storing unit 33, and the fourth storing unit 34 with the eighth transport path 418. The eleventh transport path 423 transports banknotes from the eighth transport path 418 toward each of the storing units 31 to 34 and from each of the storing units 31 to 34 toward the eighth transport path 418. More specifically, the eleventh transport path 423 extends in the front-rear direction. An end of the eleventh transport path 423 is connected to the first storing unit 31. The eleventh transport path 423 includes three branches 424, 425, and 426. The branch 424 is connected to the second storing unit 32. The branch 425 is connected to the third storing unit 33. The branch 426 is connected to the fourth storing unit 34. Junctions of the branches 424, 425, and 426 are provided with diverters.

The second lower transport unit 43 is disposed between the fourth storing unit 34 and the fifth storing unit 35 and above the compact storing unit 36. The second lower transport unit 43 extends in the up-and-down direction. The second lower transport unit 43 includes a twelfth transport path 431. The twelfth transport path 431 connects the compact storing unit 36 and the tenth transport path 422 of the lower transport unit 42 with each other. The twelfth transport path 431 extends in the up-and-down direction. The twelfth transport path 431 transports the banknotes from the tenth transport path 422 toward the compact storing unit 36 and from the compact storing unit 36 toward the tenth transport path 422.

The twelfth transport path 431 further includes a branch 432 and a branch 433. Junctions of the branches 432 and 433 are provided with diverters.

Note that the configuration of the storing unit in the banknote handling apparatus 1 shown in FIG. 2 is an example. The number, arrangement, and the configuration of the storing units accommodated in the safe housing 131 are not limited to those shown in FIG. 2.

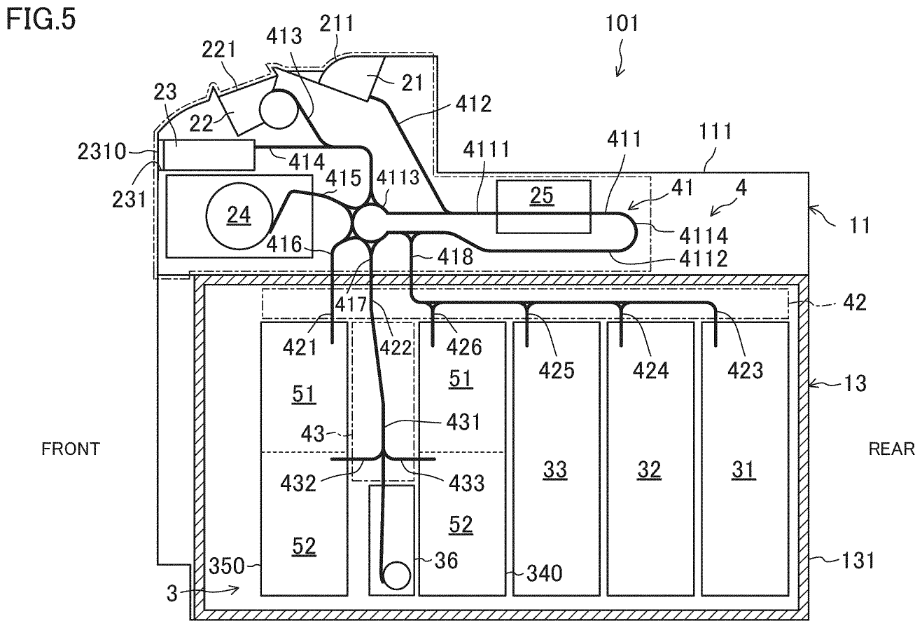

FIG. 5 illustrates a banknote handling apparatus 101 according to a variation. In the banknote handling apparatus 101, configurations of a fourth storing unit 340 and a fifth storing unit 350 are different from those of the banknote handling apparatus 1 shown in FIG. 2.

Each of the fourth storing unit 340 and the fifth storing unit 350 has two storages, that is, an upper storage 51 and a lower storage 52. The upper storage 51 is provided on an upper side. The lower storage 52 is provided under the upper storage 51. The upper storage 51 and the lower storage 52 are independent from each other. Each of the fourth storing unit 340 and the fifth storing unit 350 includes a first transport mechanism for the upper storage 51 and a second transport mechanism for the lower storage 52. Each of the fourth storing unit 34 and the fifth storing unit 35 is capable of storing banknotes in the upper storage 51 and feeding the banknotes from the upper storage 51, and is also capable of storing banknotes in the lower storage 52 and feed the banknotes from the lower storage 52.

The ninth transport path 421 connects the upper storage 51 of the fifth storing unit 350 and the sixth transport path 416 with each other Further, the branch 426 of the eleventh transport path 423 is connected to the upper storage 51 of the fourth storing unit 340.

The branch 432 of the second lower transport unit 43 is connected to the lower storage 52 of the fifth storing unit 350. The branch 433 is connected to the lower storage 52 of the fourth storing unit 340. The second lower transport unit 43 selectively transports the banknotes to the lower storage 52 of the fourth storing unit 340, the lower storage 52 of the fifth storing unit 350, and the compact storing unit 36.

Further, of the fourth storing unit 340 and the fifth storing unit 350 of the banknote handling apparatus 101 shown in FIG. 5, only the fourth storing unit 340 may include the two storages 51 and 52, or only the fifth storing unit 350 may include the two storages 51 and 52.

In some implementations, respective portions of the first to twelfth transport paths 411 to 418, 421 to 426, and 431 to 433 are provided with a tracking sensor 419 for detecting passing of a banknote and a timing sensor 4110 for detecting an edge of a banknote. A controller 15 that will be described later controls the diverters through the transport unit 4, based on a detection signal of the tracking sensor 419 and the timing sensor 4110. This configuration allows the banknotes to be transported to a predetermined destination.

As shown in FIG. 3, the banknote handling apparatus 1 includes the controller 15. The depositing unit 21, the dispensing unit 22, the reject unit 23, the temporary storage unit 24, the recognition unit 25, the transport unit 4, the first storing unit 31, the second storing unit 32, the third storing unit 33, the fourth storing unit 34, the fifth storing unit 35, and the compact storing unit 36 are connected to the controller 15 so as to be capable of exchanging signals with the controller 15.

The banknote handling apparatus 1 includes an operation unit 26 operated by an operator, a memory 27 for storing various data, and a communication unit 28 for establishing communication with a terminal 29. The operation unit 26, the memory 27, and the communication unit 28 are connected to the controller 15 so as to be capable of exchanging signals with the controller 15. The operation unit 26 includes occupation switches 261. As shown in FIG. 1, the occupation switches 261 are provided on both right and left side portions of the upper housing 111 of the banknote handling apparatus 1. The occupation switch 261 is, for example, a touch switch. Further, the operator (e.g., a teller) operates the terminal 29 to execute various processes performed by using the banknote handling apparatus 1.

The communication unit 28 is connected to a management device 201 and to a mobile terminal 202 via network 280. The management device 201 may be a device that manages a bank system. The management device 201 is disposed, for example, away from the place where the banknote handling apparatus 1 is installed. The mobile terminal 202 is, for example, a tablet terminal or a smartphone. The mobile terminal 202 is, for example, a terminal carried by the bank manager.

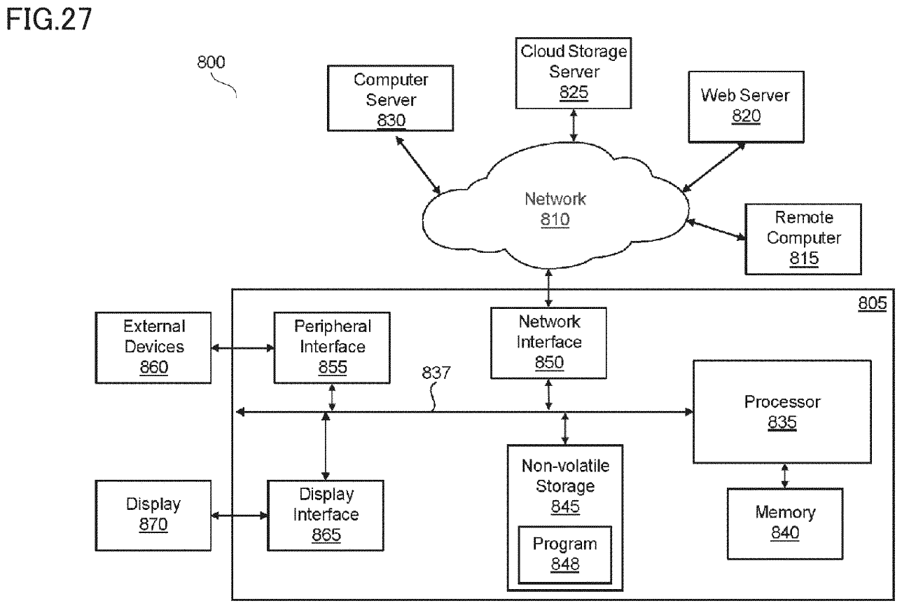

The controller 15 controls the depositing unit 21, the dispensing unit 22, the reject unit 23, the temporary storage unit 24, the recognition unit 25, the transport unit 4, the first storing unit 31, the second storing unit 32, the third storing unit 33, the fourth storing unit 34, the fifth storing unit 35, and the compact storing unit 36 so that various processes be executed when the operator operates the operation unit 26 or when the operator operates the terminal 29. It will be described below how the banknote handling apparatus 1 executes various processes with reference to the drawings. The controller 15 may be realized by executable instructions of software and specialized hardware. In particular, controller 15 is implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor. Further details of the controller 15 are described in reference to FIG. 27.

(Depositing Process)

During depositing process, the banknote handling apparatus 1 stores banknotes in the storage units. The operator inserts the banknotes to be deposited into the depositing unit 21. The depositing unit 21 takes the banknotes one by one into the apparatus. The transport unit 4 transports the banknotes to the recognition unit 25. The recognition unit 25 recognizes the banknotes. The transport unit 4 transports the banknotes to the first storing unit 31, the second storing unit 32, the third storing unit 33, the fourth storing unit 34, the fifth storing unit 35, or the compact storing unit 36, in accordance with the recognition results of the recognition unit 25. The storing units 31 to 36 store the banknotes. The transport unit 4 transports the banknotes recognized by the recognition unit 25 as banknotes to be rejected to the reject unit 23.

When all the banknotes inserted into the depositing unit 21 are taken into the banknote handling apparatus 1, the terminal 29, for example, shows the deposited amount. The depositing process ends when the operator operates the terminal 29 or the operation unit 26 to confirm the depositing process. The controller 15 stores the data relating to the banknotes stored in the storing units 31 to 36 in the memory 27.

In the case of using the temporary storage unit 24 during the depositing process, the transport unit 4 transports the banknotes that have passed through the recognition unit 25 to the temporary storage unit 24. The temporary storage unit 24 stores the banknotes. After all the banknotes inserted into the depositing unit 21 are taken into the banknote handling apparatus 1, the terminal 29, for example, shows the deposited amount. The operator may choose whether to confirm the depositing process or to cancel the depositing process by operating the terminal 29 or the operation unit 26. When the operator confirms the depositing process, the transport unit 4 transports the banknotes fed by the temporary storage unit 24 to the first storing unit 31, the second storing unit 32, the third storing unit 33, the fourth storing unit 34, the fifth storing unit 35, or the compact storing unit 36. The storing units 31 to 36 store the banknotes. When the operator cancels the depositing process, the transport unit 4 transports the banknotes fed by the temporary storage unit 24 to the dispensing unit 22. Thus, the banknotes to be deposited are returned.

(Dispensing Process)

During dispensing process, the banknote handling apparatus 1 dispenses the banknotes to the outside of the banknote handling apparatus 1. The storing units 31 to 36 feed the banknotes to be dispensed. The transport unit 4 transports the banknotes to the recognition unit 25. The recognition unit 25 recognizes the banknotes. The transport unit 4 transports the banknotes after recognition to the dispensing unit 22. The dispensing unit 22 keeps the banknotes to be dispensed. The transport unit 4 transports the banknotes recognized by the recognition unit 25 as banknotes to be rejected to the reject unit 23. The reject unit 23 stores the rejected banknotes. The dispensing process ends when all the banknotes to be dispensed are dispensed to the dispensing unit 22. The controller 15 deletes the data relating to the banknotes fed by the storing units 31 to 36 from the memory 27.

(Configuration of Upper Transport Unit)

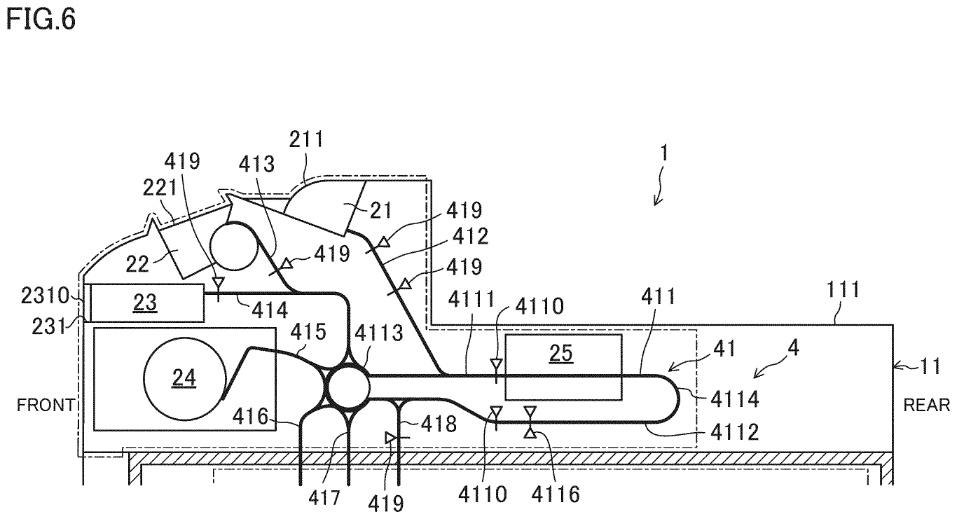

FIG. 6 illustrates a configuration of the upper transport unit 41 in an enlarged scale. As mentioned above, the upper transport unit 41 includes the first transport path 411, a second transport path 412, the third transport path 413, the fourth transport path 414, the fifth transport path 415, the sixth transport path 416, the seventh transport path 417, and the eighth transport path 418.

The upper transport unit 41 includes the tracking sensor 419 and the timing sensor 4110. In the example configuration shown in FIG. 6, two tracking sensors 419 are disposed in the second transport path 412, one in the third transport path 413, one in the fourth transport path 414, and one in the eighth transport path 418. These tracking sensors 419 are comprised of optical sensors. Specifically, in this example configuration, each tracking sensor 419 is comprised of a reflective optical sensor. The reflective optical sensor includes a light emitter and a light receiver. In the reflective optical sensor, light is emitted by the light emitter toward the transport path, reflected on the surface of the banknote being transported, and received on the light receiver. In this way, the reflective optical sensor detects the banknotes.

The timing sensor 4110 is provided to each of the upper path 4111 of the first transport path 411 and the lower path 4112 of the first transport path 411. More specifically, the first timing sensor 4110 is arranged approximately in the center portion of the upper path 4111 in the front-rear direction. The second timing sensor 4110 is arranged approximately in the center portion of the lower path 4112 in the front-rear direction. The timing sensors 4110 detect leading edges of the banknotes transported forward and backward along the upper path 4111 or the lower path 4112. The controller 15 determines the timing of moving the diverters provided in the upper transport unit 41, based on detection signals of the timing sensors 4110. Moving the diverters at an appropriate timing allows the banknotes being transported along the first transport path 411 to be transported to a predetermined destination. The timing sensors 4110 are comprised of optical sensors, specifically, reflective optical sensors.

(Configuration of Curved Portion)

FIG. 7 illustrates a configuration of the front curved portion 4113 in an enlarged scale. The front curved portion 4113 includes one driving roller 44, a plurality of driven rollers 45, and a plurality of diverters 461, 462, 463, and 464.

The driving roller 44 forms an inner peripheral portion of the front curved portion 4113. The driving roller 44 makes a forward rotation and a reverse rotation about an axis X1. A driving source is connected to the driving roller 44. The driving roller 44 rotates by the driving force of the driving source.

The axis X1 extends in the right-left direction of the banknote handling apparatus 1. The driving roller 44 has a columnar or cylindrical shape with the axis X1 as a central axis. Approximately ¾ of the outer peripheral surface of the driving roller 44 forms the transport path of the front curved portion 4113.

The driven rollers 45 are disposed at intervals from each other along the outer peripheral surface of the driving roller 44. There are five driven rollers 45 in the example configuration of FIG. 7. The five driven rollers 45 are disposed at even intervals from each other. Each of the driven rollers 45 abuts on the outer peripheral surface of the driving roller 44. Each of the driven rollers 45 has a diameter smaller than the diameter of the driving roller 44. Each of the driven rollers 45 is driven to rotate when the driving roller 44 rotates. Each of the driven rollers 45 has a rotational speed higher than the rotational speed of the driving roller 44.

When the driving roller 44 rotates, the banknote interposed between the outer peripheral surface of the driving roller 44 and the driven rollers 45 is transported forward and backward. In FIG. 7, “forward” refers to the clockwise direction and “backward” refers to the counterclockwise direction. The driving roller 44 is an example of a second transport roller. In the present embodiment, the driving roller 44 rotates at a rotational speed of 441 rpm, and the driven roller 45 rotates at a rotational speed of 1910 rpm. Both rollers have a circumferential speed of 1600 mm/s. Further, if the diameter of the driving roller 44 is twice as long as the diameter of the driven roller 45, its rotational speed is half (½) of the rotational speed of the driven roller 45.

Although shown only partially in FIG. 7, the upper path 4111 of and the lower path 4112 of the first transport path 411 are provided with transport rollers 4115 for transporting the banknotes. A diameter of the transport roller 4115 is smaller than the diameter of the driving roller 44. The transport roller 4115 rotates at a rotational speed higher than the rotational speed of the driving roller 44. In the first transport path 411, the banknote is transported at a constant speed.

The controller 15 may change the rotational speed of the driving roller 44 and the rotational speed of the transport rollers 4115 based on the recognition results of the recognition unit 25. For example, if the recognition unit 25 recognizes an unfit note, the controller 15 may reduce the rotational speed of the driving roller 44 and the rotational speed of the transport roller 4115.

The diverter 461 is provided at the connecting portion between the third transport path 413 and the front curved portion 4113. The diverter 462 is provided at the connecting portion between the fifth transport path 415 and the front curved portion 4113. The diverter 463 is provided at the connecting portion between the sixth transport path 416 and the front curved portion 4113. The diverter 464 is provided at the connecting portion between the seventh transport path 417 and the front curved portion 4113. Each of the diverters 461, 462, 463, and 464 are disposed between the driven rollers 45 that are adjacent in the circumferential direction.

Each of the diverters 461 to 464 turns on an axis. When the banknote is transported forward through the first transport path 411, the diverter 461 changes the transport direction of the banknote to three directions: a first forward direction from the front curved portion 4113 toward the third transport path 413; a second forward direction from the third transport path 413 toward the front curved portion 4113; and a third forward direction to transport the banknote along the front curved portion 4113. When the banknote is transported backward through the first transport path 411, the diverter 461 changes the transport direction of the banknote to three directions: a first backward direction from the front curved portion 4113 toward the third transport path 413; a second backward direction from the third transport path 413 toward the front curved portion 4113; and a third backward direction to transport the banknote along the front curved portion 4113.

Likewise, when the banknote is transported forward through the first transport path 411, the diverter 462 changes the transport direction of the banknote to three directions: a first forward direction from the front curved portion 4113 toward the fifth transport path 415; a second forward direction from the fifth transport path 415 toward the front curved portion 4113; and a third forward direction to transport the banknote along the front curved portion 4113. When the banknote is transported backward through the first transport path 411, the diverter 462 changes the transport direction of the banknote to three directions: a first backward direction from the front curved portion 4113 toward the fifth transport path 415; a second backward direction from the fifth transport path 415 toward the front curved portion 4113; and a third backward direction to transport the banknote along the front curved portion 4113.

When the banknote is transported forward through the first transport path 411, the diverter 463 changes the transport direction of the banknote to three directions; a first forward direction from the front curved portion 4113 toward the sixth transport path 416; a second forward direction from the sixth transport path 416 toward the front curved portion 4113; and a third forward direction to transport the banknote along the front curved portion 4113. When the banknote is transported backward through the first transport path 411, the diverter 463 changes the transport direction of the banknote to three directions: a first backward direction from the front curved portion 4113 toward the sixth transport path 416; a second backward direction from the sixth transport path 416 toward the front curved portion 4113; and a third backward direction to transport the banknote along the front curved portion 4113.

When the banknote is transported forward through the first transport path 411, the diverter 464 changes the transport direction of the banknote to three directions: a first forward direction from the front curved portion 4113 toward the seventh transport path 417; a second forward direction from the seventh transport path 417 toward the front curved portion 4113; and a third forward direction to transport the banknote along the front curved portion 4113. When the banknote is transported backward through the first transport path 411, the diverter 464 changes the transport direction of the banknote to three directions: a first backward direction from the front curved portion 4113 toward the seventh transport path 417; a second backward direction from the seventh transport path 417 toward the front curved portion 4113; and a third backward direction to transport the banknote along the front curved portion 4113.

The front curved portion 4113 configured as described above includes the driving roller 44. The driving roller 44 functions as both a roller and a guide of the curved portion having a known configuration. The front curved portion 4113 including the driving roller 44 has a smaller number of parts than that of a known configuration. Further, the forward or reverse rotation of the driving roller 44 while the banknote is transported causes the inner peripheral portion of the front curved portion 4113 to rotate. Thus, jamming of banknotes is less likely to occur. Even if the front curved portion 4113 is provided with a plurality of three-way diverters 461 to 464, jamming of banknotes is less likely to occur in the front curved portion 4113 due to the rotation of the driving roller 44. The transportation of the banknote in the front curved portion 4113 is improved.

Further, the timing sensors 4110 determining the driving timing of each of the diverters 461 to 464 of the front curved portion 4113 are disposed in the upper path 4111 and the lower path 4112. Since the timing sensors 4110 are not provided in the front curved portion 4113, the configuration of the front curved portion 4113 is simplified. The simplified configuration also contributes to reducing jamming of banknotes in the front curved portion 4113.

Since the transportation of the banknote in the front curved portion 4113 is good, the banknote is stably transported to the dispensing unit 22 through the third transport path 413 or to the reject unit 23 through the fourth transport path 414. The banknote is stably transported to the temporary storage unit 24 through the fifth transport path 415 or to the fifth storing unit 35 through the sixth transport path 416. The banknote is stably transported to the second lower transport unit 43 through the seventh transport path 417.

In the banknote handling apparatus 101 shown in FIG. 6, the banknote is stably transported to the upper storage 51 of the fifth storing unit 35 through the sixth transport path 416. Further, the banknote is stably transported through the seventh transport path 417 to the lower storage 52 of the fifth storing unit 35 or to the lower storage 52 of the fourth storing unit 34.

The banknotes to be stored in the first to fourth storing units 31 to 34 are transported to the eighth transport path 418 connected to the lower path 4112. When the banknote is transported forward through the first transport path 411, the diverter 465 provided at the junction with the eighth transport path 418 changes the transport direction of the banknote to three directions: a first forward direction from the lower path 4112 toward the eighth transport path 418, a second forward direction from the eighth transport path 418 toward the lower path 4112; and a third forward direction to transport the banknote along the lower path 4112. When the banknote is transported backward through the first transport path 411, the diverter 465 changes the transport direction of the banknote to three directions: a first backward direction from the lower path 4112 to the eighth transport path 418; a second forward direction from the eighth transport path 418 toward the lower path 4112; and a third backward direction to transport the banknote along the lower path 4112.

Each of the diverters 461 to 465 transports the banknote to a predetermined destination by switching the transport direction of the banknote, based on the recognition results of the recognition unit 25.

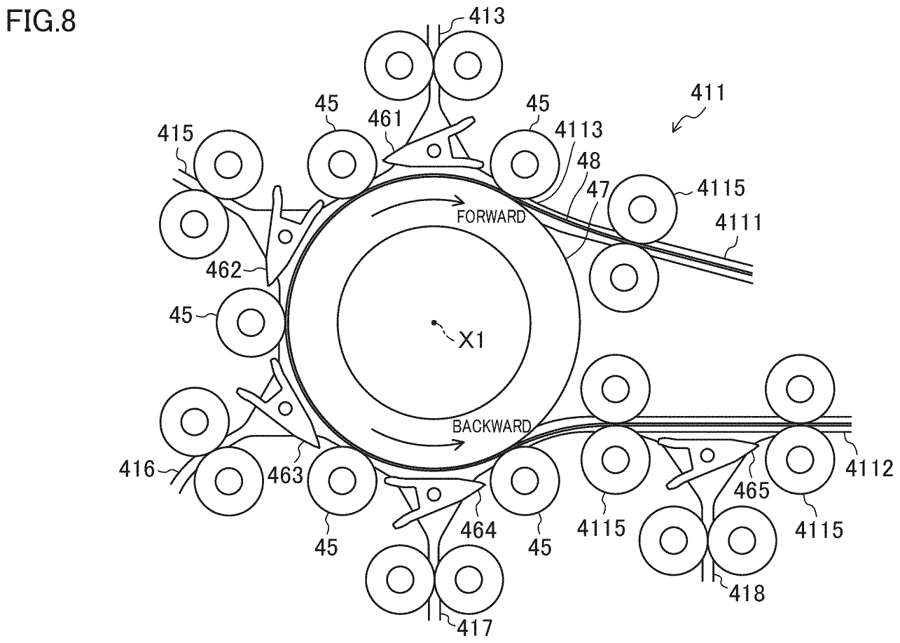

FIG. 8 illustrates a variation of the front curved portion 4113. The front curved portion 4113 of FIG. 8 includes one pulley 47 and a transport belt 48 wound around the pulley 47, instead of the driving roller 44. The inner peripheral portion of the front curved portion 4113 is comprised of the transport belt 48. The pulley 47 makes a forward rotation and a reverse rotation. The transport belt 48 runs forward and backward in accordance with the rotation of the pulley 47. The banknote interposed between the transport belt 48 and the driven rollers 45 is transported forward and backward.

The front curved portion 4113 of this configuration, too, has a smaller number of parts than that of a known configuration. Further, the forward or reverse rotation of the pulley 47 while the banknote is transported causes the transport belt 48, which comprises the inner peripheral portion of the front curved portion 4113, to run. Thus, jamming of banknotes is less likely to occur. Even if the front curved portion 4113 is provided with a plurality of three-way diverters 461 to 464, jamming of banknotes is less likely to occur in the front curved portion 4113. The transportation of the banknote in the front curved portion 4113 is improved.

In the example configuration of FIG. 7, the larger the diameter of the driving roller 44, the longer the perimeter of the driving roller 44 is. In this case, the number of branches connected to the front curved portion 4113 may be increased. Likewise, in the example configuration of FIG. 8, the larger the diameter of the pulley 47, the longer the perimeter of the pulley 47 is. Thus, the number of branches connected to the front curved portion 4113 may be increased.

(Control of Sensor Cleaning Alarm)

Transporting the banknotes along the transport path accompanies the generation of paper powder. The generated paper powder and/or dust is gradually deposited on the light emitter and/or the light receiver of the optical sensor provided in the transport path. An increase in the deposited amount of the paper powder and/or dust reduces the detection accuracy of the optical sensor. That is, the banknote detection accuracy of the tracking sensor 419 or the timing sensor 4110 decreases. A decrease in the detection accuracy of the sensors may cause an obstruction in the control of the driving timing of each of the diverters. For this reason, it is necessary to perform the maintenance for removing the deposited paper powder and/or dust before the detection accuracy of the optical sensor decreases.

Here, the transmissive optical sensor is a sensor that detects from a drop of the output voltage that a banknote has blocked an optical axis between the light emitter and the light receiver. With the paper powder and/or dust deposited on the light emitter and/or light receiver of the transmissive optical sensor, the output voltage in a state in which the banknote is not transported decreases. The transmissive optical sensor is capable of detecting the deposited amount of the paper powder and/or dust based on an output signal in a state in which the banknote is not transported.

However, in the banknote handling apparatus 1, the optical sensors 419 and 4110 provided in the transport paths 412, 413, 414, 418, 4111, and 4112 of the upper transport unit 41, as shown in FIG. 6, are reflective optical sensors. The reflective optical sensor has an advantage of reducing erroneous detection of banknotes even if the banknote has a transparent portion. On the other hand, unlike the transmissive optical sensor, the reflective optical sensor is, in principle, incapable of detecting the deposited amount of paper powder and/or dust.

Thus, in the banknote handling apparatus 1, the first transport path 411 is provided with the transmissive optical sensor for detecting the deposited amount of paper powder and/or dust. Specifically, as shown in FIG. 6, the transmissive optical sensor 4116 is provided in the middle portion of the lower path 4112 in the front-rear direction. If paper powder and/or dust is deposited on the optical sensor 4116, it is assumed that paper powder and/or dust is deposited on other tracking sensors 419 and timing sensors 4110, as well.

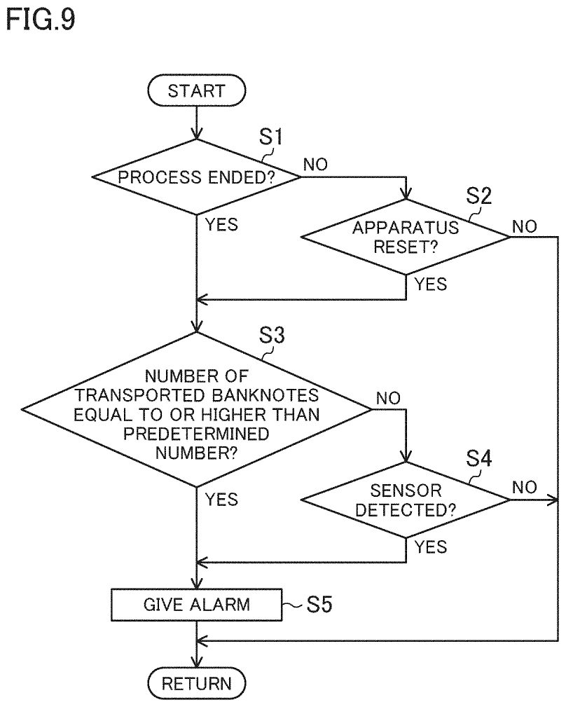

FIG. 9 is a flowchart illustrating a control procedure, performed by the controller 15, relating to a cleaning alarm for the tracking sensors 419 and the timing sensors 4110. In Step S1 after Start, the controller 15 determines whether one process ends in the banknote handling apparatus 1. If the answer in Step S1 is YES, the process proceeds to Step S3. If the answer in Step S1 is NO, the process proceeds to Step S2. The controller 15 determines whether the sensors need to be cleaned every time one process ends. The transmissive optical sensor 4116 is for detecting the deposited amount of paper powder and/or dust in a state in which the banknote is not transported.

In Step S2, the controller 15 determines whether the banknote handling apparatus 1 was reset. For example, if jamming of banknotes occurs, the banknote handling apparatus 1 is reset after the jam is removed. If the answer in Step S2 is YES, the process proceeds to Step S3. If the answer in Step S2 is NO, the process returns.

In Step S3, the controller 15 determines whether the number of transported banknotes, counted from the time when the sensor was previously cleaned, is equal to or higher than a previously set predetermined number. If the answer in Step S3 is YES, the process proceeds to Step S5 because if the number of transported banknotes increases, the deposited amount of paper powder and/or dust increases accordingly. If the answer in Step S3 is NO, the process proceeds to Step S4.

In Step S4, the controller 15 determines whether the deposited amount of paper powder and/or dust exceeds a predetermined value, based on the detection signal of the transmissive optical sensor 4116. Specifically, if the output voltage of the transmissive optical sensor 4116 in a state in which the banknote is not transported is equal to or lower than the predetermined value, the controller 15 may determine that the deposited amount exceeds the predetermined value because if the deposited amount of paper powder and/or dust increases, the amount of light that can be received in the light receiver of the transmissive optical sensor 4116, and hence the output voltage, decrease. The deposited amount of paper powder and/or dust does not necessarily increase at a constant rate with respect to the increase in the number of banknotes transported, due to various causes such as a state of the banknotes transported and/or an environment in which the banknote handling apparatus 1 is used. In addition to the determination in Step S3, the controller 15 is capable of accurately determining the deposited amount of paper powder and/or dust by using the detection signal of the transmissive optical sensor 4116, as well. If the answer in Step S4 is YES, the process proceeds to Step S5. If the answer in Step S4 is NO, the process returns.

In Step S5, the controller 15 gives the alarm regarding cleaning of the sensors. The notification that the sensors needs to be cleaned may be given to the terminal 29, the management device 201, or the mobile terminal 202, via the communication unit 28, for example. In the event that the alarm is given, a maintenance person sets the banknote handling apparatus 1 to be in an off mode, which will be described later, and cleans the sensors. The maintenance person can clean the sensors of the banknote handling apparatus 1 at an appropriate timing.

(Prevention of Incorrect Installation of Storing Units)

As shown in FIG. 4, the operator can draw the first to fifth storing units 31 to 35 out of the safe housing 131 and take them out of the banknote handling apparatus 1. FIG. 4 illustrates the banknote handling apparatus 1 with the fifth storing unit 31 taken out from the apparatus. The operator can also install the first to fifth storing units 31 to 35 in the banknote handling apparatus 1 and accommodate them in the safe housing 131. The operator may draw the first to fifth storing units 31 to 35 out of the safe housing 131 and take them out of the banknote handling apparatus 1 in the event, for example, that jamming of banknotes occurred in any one of the first to fifth storing units 31 to 35.

As mentioned above, the first to fifth storing units 31 to 35 have the same configuration. The banknote handling apparatus 1 has a structure in which it is possible to install the first to fifth storing units 31 to 35 in positions other than the correct positions. In other words, it is possible to change positions of the first to fifth storing units 31 to 35 from one another in the safe housing 131. However, the first to fifth storing units 31 to 35, if installed at incorrect positions, may lead to inaccurate operation of the banknote handling apparatus 1.

Thus, the first to fifth storing units 31 to 35 can be distinguished from each other based on, for example, the following points: (1) having a memory storing the serial number; (2) information, stored in the memory, about the denomination to be stored; (3) different attachments; and (4) a characteristic part attached. When the first to fifth storing units 31 to 35 are installed in the banknote handling apparatus 1, the controller 15 determines whether each of the storing units 31 to 35 is in the correct position, based on at least one of the points (1) to (4).

As shown in FIG. 10, the banknote handling apparatus 1 includes a display 53. The display 53 shows the installation state of the first to fifth storing units 31 to 35. The display 53 is provided on each of the front and side portions of the frame 54. The first to fifth storing units 31 to 35 are detachably installed inside the frame 54. The frame 54 is accommodated inside the safe housing 131 and drawn out from the safe housing 131, together with the first to fifth storing units 31 to 35.

The display 53 may be comprised of, for example, a plurality of light emitting diodes (LEDs). An LED 531 is disposed on the front portion of the frame 54. Further, five LEDs 532 to 536 are aligned in the front-rear direction on the side portion of the frame 54. The controller 15 controls turning the LEDs 531 to 536 on and off.

The five LEDs 532 to 536 aligned in the front-rear direction correspond to the first to fifth storing units 31 to 35 aligned in the front-rear direction, respectively. The positions of the LEDs 532 to 536 in the front-rear direction correspond to the positions of the first to fifth storing units 31 to 35 in the front-rear direction. The LEDs 532 to 536 respectively indicate the installation states of the first to fifth storing units 31 to 35.

Specifically, if the first storing unit 31 is installed correctly, the LED 532 lights up in green, for example. If the second storing unit 32 is installed correctly, the LED 533 lights up in green, for example. If the third storing unit 33 is installed correctly, the LED 534 lights up in green, for example. If the fourth storing unit 34 is installed correctly, the LED 535 lights up in green, for example. If the fifth storing unit 35 is installed correctly, the LED 536 lights up in green, for example. If the storing units 31 to 35 are installed correctly, the LEDs 532 to 536 may be turned off.

If the first storing unit 31 is installed incorrectly, the LED 532 lights up in red, for example. If the second storing unit 32 is installed incorrectly, the LED 533 lights up in red, for example. If the third storing unit 33 is installed incorrectly, the LED 534 lights up in red, for example. If the fourth storing unit 34 is installed incorrectly, the LED 535 lights up in red, for example. If the fifth storing unit 35 is installed incorrectly, the LED 536 lights up in red, for example. If the storing units 31 to 35 are installed incorrectly, the LEDs 532 to 536 may be turned off. Further, incorrect installation of the storing units 31 to 35 includes both of the case in which the installation positions of the storing units 31 to 35 are wrong, and the case in which the installation state of the storing units 31 to 35 is inaccurate.

If all of the first to fifth storing units 31 to 35 are installed correctly, the LED 531 lights up in green, for example. If all of the first to fifth storing units 31 to 35 are installed correctly, the LED 531 may be turned off. If at least one of the first to fifth storing units 31 to 35 is installed incorrectly, the LED 531 lights up in red, for example. If at least one of the first to fifth storing units 31 to 35 is installed incorrectly, the LED 531 may be turned off.

In taking out and installing the first to fifth storing units 31 to 35, the operator draws the frame 54 out of the safe housing 131 until the LEDs 532 to 536 are exposed. After installing the first to fifth storing units 31 to 35, the operator can confirm whether each of the first to fifth storing units 31 to 35 is installed correctly by looking at the LEDs 532 to 536. The risk of incorrect installation of the first to fifth storing units 31 to 35 is reduced.

After the first to fifth storing units 31 to 35 are installed, the operator pushes the frame 54 into the safe housing 131. When the frame 54 is pushed into the safe housing 131, the LEDs 532 to 536 provided on the side portion of the frame 54 are hidden inside the safe housing 131. For this reason, the operator is unable to see the LEDs 532 to 536. However, the operator can see the LED 531 on the front portion of the frame 54. As described above, the operator can see whether at least one of the first to fifth storing units 31 to 35 is installed incorrectly by looking at the LED 531. The operator can confirm once more whether each of the first to fifth storing units 31 to 35 is installed correctly before closing the door 1310. The risk of incorrect installation of the first to fifth storing units 31 to 35 may be reduced.

When the door 1310 is closed, the banknote handling apparatus 1 performs an initial operation. In the initial operation, the controller 15 confirms whether each of the first to fifth storing units 31 to 35 is installed correctly. In a case in which any of the first to fifth storing units 31 to 35 is not installed correctly, the banknote handling apparatus 1 ends in error. In such a case, the operator has to open the door 1310 once again, and correct the wrong installation of the storing units. However, in some cases, in order to improve the security of the safe unit 13, the banknote handling apparatus 1 may be configured such that the door 1310 cannot be opened again until a predetermined time lapses. As described above, the configuration which allows the operator to confirm the installation state of the first to fifth storing units 31 to 35 when the first to fifth storing units 31 to 35 are installed, and the configuration which allows the operator to confirm the installation state of the first to fifth storing units 31 to 35 once again before the door 1310 is closed are effective in reducing the probability of closing the door 1310 with the first to fifth storing units 31 to 35 installed incorrectly. Such configurations keep the time of recovery work from increasing.

(Configuration that Regulates Drawing-Out of Unit)

As shown in FIG. 10, the frame 54 to be drawn out from the safe housing 131 is drawn out from the safe housing 131, and pushed into the safe housing 131, by being guided by a slide rail 541. The first to fifth storing units 31 to 35 and the compact storing unit 36 are installed in the frame 54. The lower transport unit 42 and the second lower transport unit 43 are also supported on the frame 54. As shown in FIG. 4, the lower transport unit 42 and the second lower transport unit 43 are drawn out of the safe housing 131 together with the frame 54. A unit 1311 configured by including at least the frame 54, the first to fifth storing units 31 to 35, the compact storing unit 36, the lower transport unit 42, and the second lower transport unit 43 is relatively heavy. In order to keep the slide rail 541 from breaking when the unit 1311 is being drawn out from the safe housing 131, the banknote handling apparatus 1 is configured to limit how far the unit 1311 can be draw out.

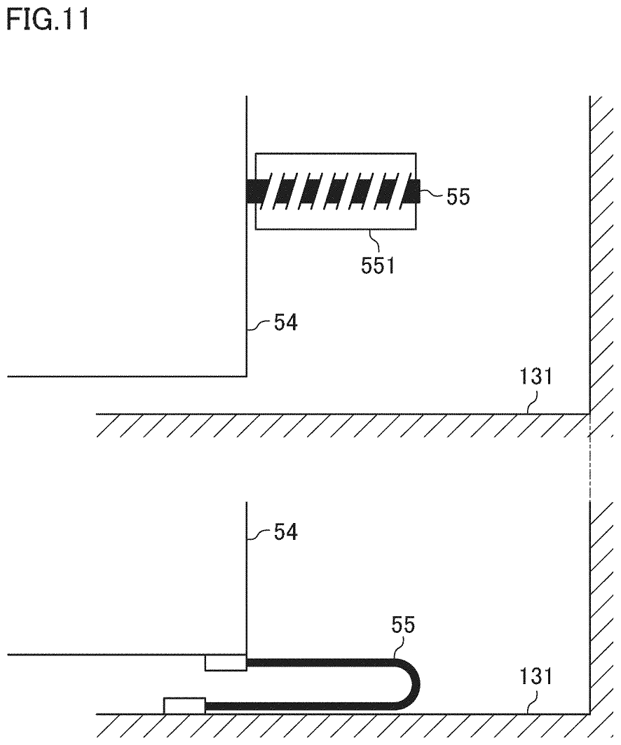

Specifically, the banknote handling apparatus 1 includes a belt member 55. As shown in FIGS. 4 and 11, the belt member 55 has its first end fixed to a bottom inside the safe housing 131 and its second end fixed to a rear end portion of the frame 54. The belt member 55 has a high rigidity relative to the tensile load in its longitudinal direction, and also has high strength. That is, the belt member 55 is less likely to deform in the longitudinal direction and hardly breaks. As indicated with a solid line in FIG. 4, when the unit 1311 is drawn out of the safe housing 131, the belt member 55 connecting the unit 1311 and the safe housing 131 is pulled to the front of the banknote handling apparatus 1. The belt member 55 regulates how far the unit 1311 can be drawn out at the maximum.

Further, the belt member 55 is relatively thin and may warp in its thickness direction. When the unit 1311 is pushed into the safe housing 131, the belt member 55 is bent so as to be folded, as shown in FIG. 11. In this way, the belt member 55 allows the unit 1311 to be pushed into the safe housing 131. As indicated by a two-dot chain line in FIG. 4, when the unit 1311 is entirely accommodated in the safe housing 131, the belt member 55 is pulled rearward inside the safe housing 131 and restricts the unit 1311 from being pushed too deep into the safe housing 131.

Here, as shown in the upper and lower drawings of FIG. 11, when the unit 1311 is drawn out or pushed in, the intermediate portion of the belt member 55 is not supported. As shown in the upper portion of FIG. 11, the belt member 55 has a relatively narrow width. For this reason, when the unit 1311 is drawn out or pushed in, the belt member 55 can freely move in its width direction. When the belt member 55 moves in the width direction, it may get interposed between the unit 1311 and the safe housing 131, which may cause an obstruction in inserting and drawing out the unit 1311.

Thus, a regulation member 551 is attached to the belt member 55. The regulation member 551 is like a film. The regulation member 551 is wider than the belt member 55. The regulation member 551 is less likely to deform in the width direction. The regulation member 551, similarly to the belt member 55, may warp in its thickness direction.

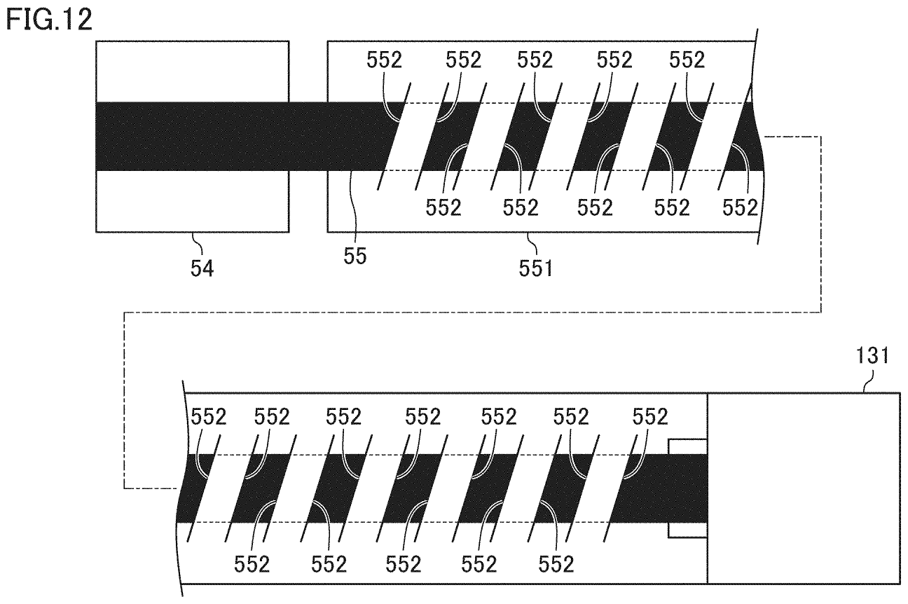

As shown in the enlarged view of FIG. 12, the regulation member 551 has a large number of slits 552 formed at intervals in its longitudinal direction. The belt member 55 is inserted in the slits 552 so as to pass alternately through the front face and the back surface of the regulation member 551. In this way, the belt member 55 and the regulation member 551 are integrated.

Movements of the belt member 55 and the regulation member 551 relative to each other in the width direction are regulated by the length of each slit 552. On the other hand, the belt member 55 and the regulation member 551 may move relative to each other in the longitudinal direction. Here, orientation of each of the slits 552 is inclined with respect to the width direction of the belt member 55. This configuration reduces the possibility that the belt member 55 is caught on the slits 552 when the belt member 55 and the regulation member 551 move relative to each other in the longitudinal direction.

As shown in FIG. 12, a first end of the regulation member 551 is fixed to the safe housing 131. A second end of the regulation member 551 is not fixed to the frame 54. When the belt member 55 and the regulation member 551 bend, the difference between their curvature radii may be absorbed by the relative movements of the belt member 55 and the regulation member 551 in the longitudinal direction. The operator can smoothly draw out, and push the unit 1311 into, the safe housing 131. The regulation member 551 may have its first end not fixed to the safe housing 131 and have its second end fixed to the frame 54, contrary to the above.

The above-described belt member 55 is capable of effectively regulating how far the unit 1311 can be drawn out using an inexpensive configuration.

(Configuration of Occupation Light)

The banknote handling apparatus 1 may be shared by two tellers. The teller who wants to use the banknote handling apparatus 1 operates the occupation switch 261 located toward the teller. The teller who operates the occupation switch 261 is allowed to use the banknote handling apparatus 1 exclusively.

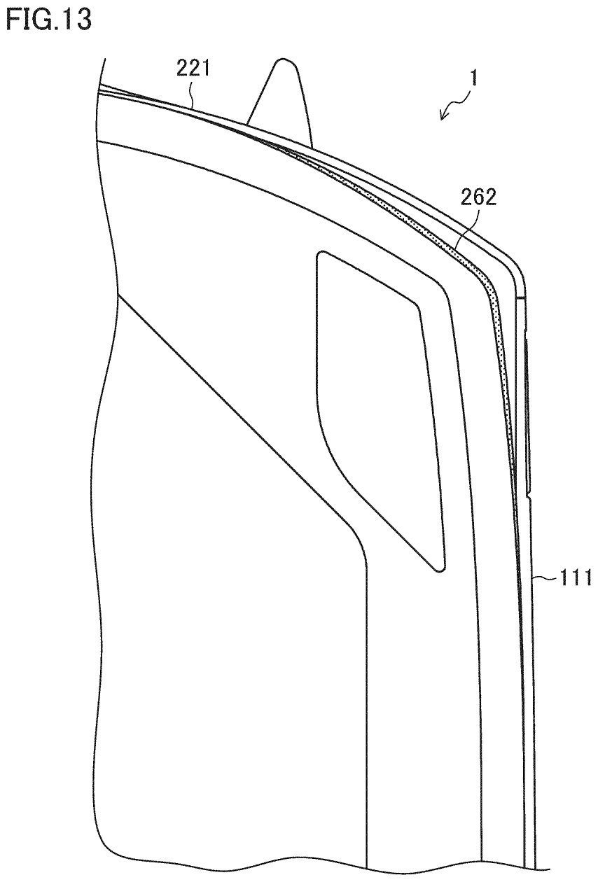

The banknote handling apparatus 1 includes an occupation light 262. The occupation light 262 displays the state of occupation of the banknote handling apparatus 1. The occupation light 262 is provided at the front portion of the upper housing Il1 of the banknote handling apparatus 1. The occupation light 262 is provided on each of both right and left side portions of the upper housing 111. The occupation light 262 extends from the upper side to the front side of the upper housing 111 and, as shown in FIG. 13, has an inverted L-shape in a side view.

When the occupation switch 261 on the right side is operated, the occupation light 262 on the right side lights up and the occupation light 262 on the left side turns off. When the occupation switch 261 on the left side is operated, the occupation light 262 on the left side lights up and the occupation light 262 on the right side turns off. In this way, it is shown which of the tellers on the right side or the left side can use the banknote handling apparatus 1. In the state in which neither of the occupation switches 261 on the right side and left side is operated, the two occupation lights 262 are turned off.

As shown in FIG. 1, both of the two occupation lights 262 are visible when the banknote handling apparatus 1 is viewed from the front. However, as shown in FIG. 13, when the banknote handling apparatus 1 is viewed from the side, the occupation light 262 on the viewer's side is visible, whereas the occupation light 262 on the opposite side is hidden by the upper housing 111 and invisible. In other words, as shown in FIG. 13, the teller on the left side of the banknote handling apparatus 1 can see that the occupation light 262 on the left side is lit. However, the teller on the left side cannot see that the occupation light 262 on the right side is lit. Likewise, the teller on the right side of the banknote handling apparatus 1 can see that the occupation light 262 on the right side is lit. However, the teller on the right side cannot see that the occupation light 262 on the left side is lit.

Being able to see the occupation light 262 on the left side lit, the teller on the left side may recognize that he/she is the one who is using the banknote handling apparatus 1. However, when the teller on the right side operates the occupation switch 261, the occupation light 262 on the left side is turned off and the teller on the left side cannot see that the occupation light 262 on the right side is lit. The teller on the left side does not recognize that the occupation switch 261 is lit. The teller on the left side recognizes that the two occupation switches 261 are turned off.

Thus, when the teller on the right side operates the occupation switch 261 to cause the banknote handling apparatus 1 to execute, for example, a dispensing process, this configuration reduces the risk that the teller on the left side takes, by mistake, the banknotes dispensed to the dispensing unit 22. Having the occupation light 262 with the devised configuration, the banknote handling apparatus 1 allows the teller who operated the occupation switch 261 to take out the banknotes dispensed to the dispensing unit 22 correctly. The banknote handling apparatus 1 is capable of reducing erroneous processes in the bank.

(Configuration Reducing False Detection by Sensor in Dispensing Unit)

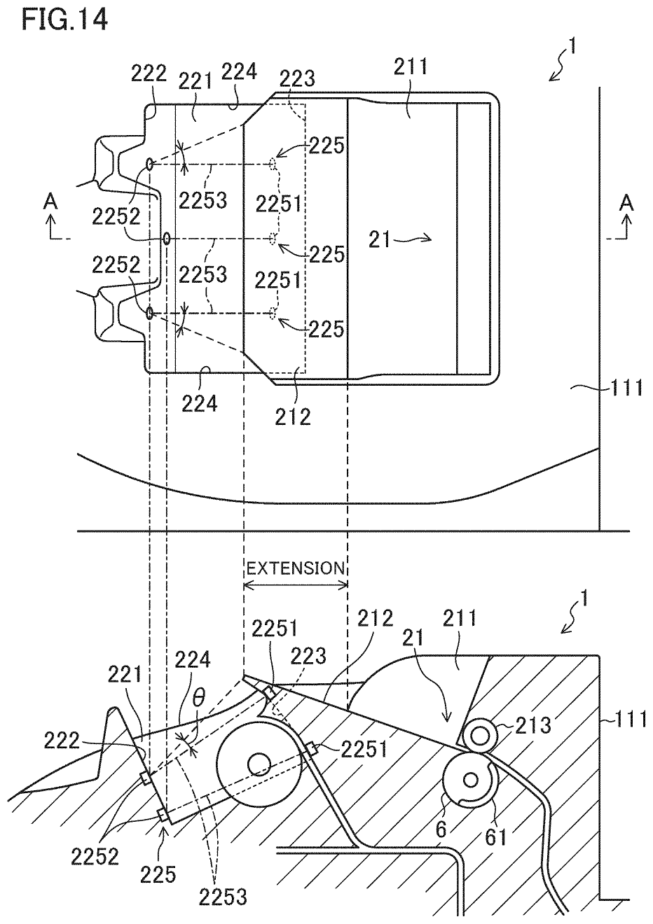

FIG. 14 consists of an upper drawing and a lower drawing. The upper drawing is a plan view of the outlet 221 and the inlet 211. The lower drawing is a cross-sectional view of the outlet 221 and the inlet 211 from the side. As described above, the outlet 221 is provided in the upper portion of the upper housing 111 at a position closer to the front than the inlet 211. Here, the outlet 221 has approximately a rectangular shape in a plan view. The dispensing unit 22 is comprised of a front wall portion 222, a rear wall portion 223, and two side wall portions 224. The outlet 221 is widely open upward. This configuration facilitates visibility of the banknotes dispensed to the outlet 221 from the operator and taking out the banknotes from the outlet 221 by the operator.

The dispensing unit 22 is provided with a remainder sensor 225 that detects the banknotes. The remainder sensor 225 is comprised of a transmissive optical sensor. In an example configuration shown in FIG. 14, the dispensing unit 22 includes three remainder sensors 225. A light emitter 2251 of the remainder sensor 225 is provided on the rear wall portion 223 of the dispensing unit 22. A light receiver 2252 is provided on the front wall portion 222. A banknote remaining in the dispensing unit 22 obstructs optical axes 2253 of the remainder sensors 225. This configuration allows the remainder sensors 225 to detect the remaining banknotes.

As described above, the outlet 221 is widely open. For this reason, the light receiver 2252 provided at the front wall portion 222 may receive ambient light of the surroundings of the banknote handling apparatus 1. Such a case leads to false detections by the remainder sensors 225.

Thus, the banknote handling apparatus 1 is configured such that the ambient light is less likely to enter the light receivers 2252 of the remainder sensors 225. Specifically, the front side of the inlet 211 is provided with an extension 212. The extension 212 extends obliquely upward from the front portion of the inlet 211 toward the front. The extension 212 also extends in the right-left direction so as to have approximately the same width as the inlet 211 and the outlet 221. As shown in the lower drawing of FIG. 14, a distal end portion of the extension 212 is provided like eaves extending obliquely upward from the rear wall portion 223 of the dispensing unit. The extension 212 reduces the possibility that the light receiver 2252 receives the ambient light.

Here, it was found through an experiment that false detection by the remainder sensors 225 may be effectively reduced by arranging the extension 212 at an angle θ of 13° or more with respect to the optical axes 2253 of the remainder sensors 225 so as to cover the optical axes 2253 from above and lateral sides.

The extension 212, since connected to the inlet 211, also allows the operator to insert the banknotes to the depositing unit 21 through the extension 212. The extension 212 also facilitates inserting the banknotes to the depositing unit 21.

(Configuration of Feed Roller)

As shown in the lower drawing of FIG. 14, the depositing unit 21 includes a feed roller 6 and a gate roller 213 which feed the banknotes. The feed roller 6 and the gate roller 213 are pressed against each other. The feed roller 6 and the gate roller 213 feed the banknotes kept in the depositing unit 21 one by one intermittently. The feed roller 6 includes, at a part of the outer perimeter, a rubber portion 61 having a relatively high frictional force against a banknote. In a known feed roller, the remaining portion except the rubber portion 61 is comprised of resin.

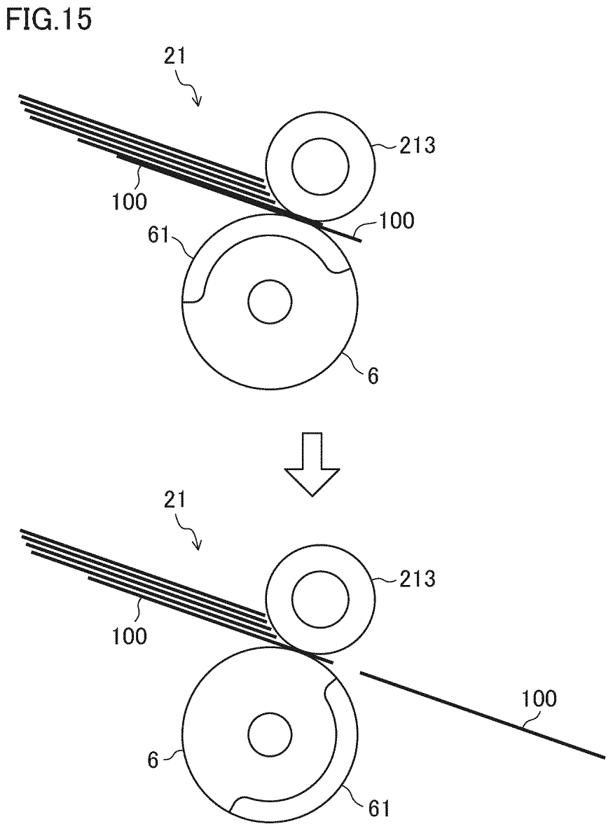

As shown in the upper drawing of FIG. 15, when the feed roller 6 rotates while a banknote 100 and the rubber portion 61 are in contact with each other, the banknote 100 is fed and the next banknote 100 remains. The banknote 10 is sandwiched between the feed roller 6 and the gate roller 213. There has been a problem that the resin portion of the feed roller 6 abrades due to the state in which the banknote 100 is kept sandwiched between the feed roller 6 and the gate roller 213.

Thus, part of the feed roller 6 of the banknote handling apparatus 1 is comprised of a metal plate.

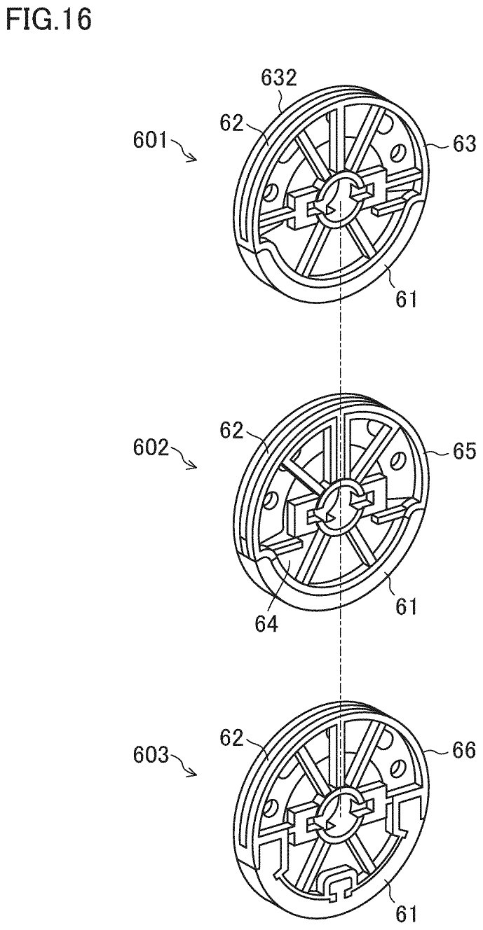

In FIG. 16, the upper drawing illustrates a feed roller 601 having a first example configuration; the middle drawing illustrates a feed roller 602 having a second example configuration; and the lower drawing illustrates a feed roller 603 having a third example configuration. These feed rollers 601 to 603 have metal plates 62 provided on the side opposite to the rubber portion 61.

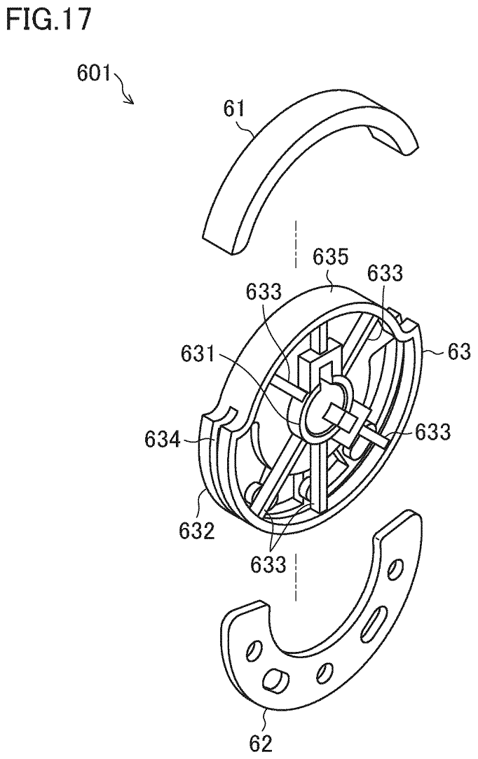

FIG. 17 is an exploded view of the feed roller 601 of the first example configuration. FIGS. 16 and 17 are upside down to each other. The feed roller 601 is comprised of a rubber portion 61, a metal plate 62, and a resin portion 63.

The metal plate 62 has approximately a C-shape. The resin portion 63 includes a hub 631, a rim 632, and a plurality of spokes 633. The spokes 633 connect the hub 631 and the rim 632. The hub 631 has a rotating shaft inserted therein. The rim 632 includes a groove 634 for the metal plate 62 to be inserted. A part of the outer peripheral surface of the rim 632 constitutes the outer peripheral surface of the feed roller 601. As shown in the upper drawing of FIG. 16, this part is made of the resin rim 632 sandwiching the metal plate 62.

The rubber portion 61 is bent in an arc shape. The rubber portion 61 is adhered to an attachment portion 635 provided on the outer peripheral portion of the rim 632.

Such a feed roller 601 may be manufactured by integrating the rubber portion 61, the metal plate 62, and the resin portion 63.

The feed roller 601 of this configuration has the metal plate 62 exposed on the outer peripheral surface of the resin portion 63, as described above. Thus, the abrasion of the resin portion 63 is reduced. Further, since the metal plate 62 constitutes only a part of the feed roller 601, the feed roller 601 is light in weight. The banknote handling apparatus 1 has low power consumption.

The resin portion 63 of the feed roller 6 may be made of, for example, polybutylene terephthalate (PBT). However, as shown in the lower drawing of FIG. 15, when the feed roller 6 rotates, the resin portion 63 slips over a banknote, which may generate frictional heat and cause the ink on the banknote (particularly, a banknote made of polymer) to melt and transfer to the resin portion 63.

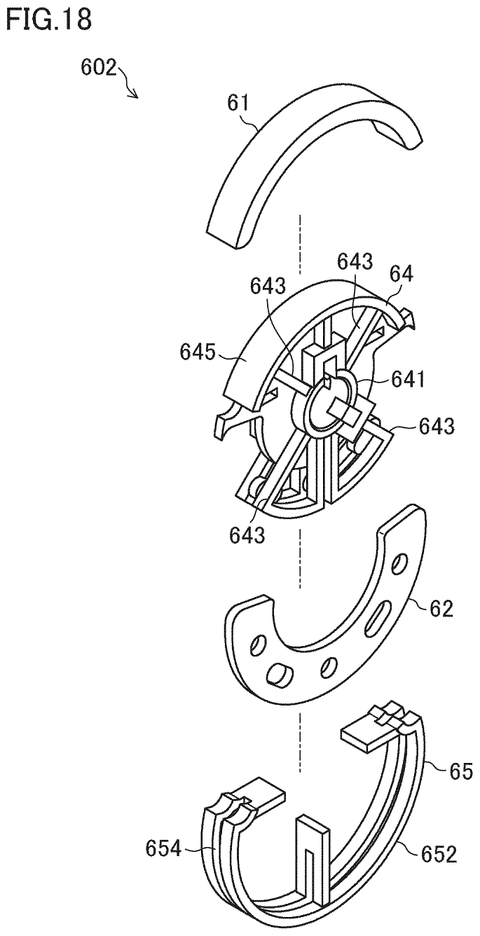

As shown in the middle drawing in FIG. 16, a part of the resin portion of the feed roller 602 may be made of polyacetal (POM) to which ink hardly adheres. FIG. 18 is an exploded view of the feed roller 602 of the second example configuration. The feed roller 602 is comprised of a rubber portion 61, a metal plate 62, a first resin portion 64, and second resin portion 65.

The first resin portion 64 includes a hub 641, spokes 643, and an attachment portion 645. The first resin portion 64 may be made of PBT. The second resin portion 65 serves as a rim 652. The second resin portion 65 includes a groove 654 for the metal plate 62 to be inserted. The second resin portion 65 is made of POM. A combination of the first resin portion 64 and the second resin portion 65 forms a region corresponding to the resin portion 63 of the feed roller 601. The feed roller 602 may be manufactured by, for example, double molding.

The feed roller 602 of this configuration has an outer peripheral surface, other than the rubber portion 61, made of POM. Thus, the transfer of the ink of the banknote to the outer peripheral surface of the feed roller 602 is reduced. Further, since the metal plate 62 is exposed on the outer peripheral surface of the feed roller 602, the abrasion of the second resin portion 65 is also reduced.

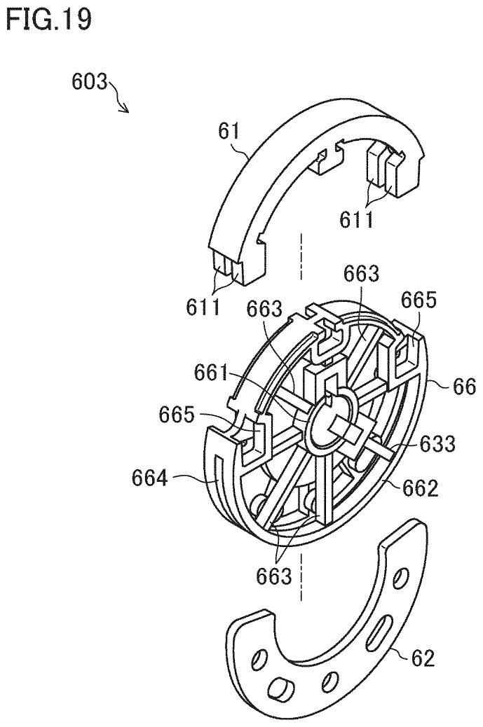

The feed roller 603 shown in the lower drawing of FIG. 16 is comprised of a rubber portion 61, a metal plate 62, and a resin portion 66. FIG. 19 is an exploded view of the feed roller 603 of the third example configuration. The resin portion 66 includes a hub 661, a rim 662, and spokes 663. The rim 662 includes a groove 664 for the metal plate 62 to be inserted. The entire resin portion 66 is made of POM. Since POM and rubber cannot adhere to each other, the rubber portion 61 and the resin portion 66 are provided with retainers 611 and 665, respectively.

The feed roller 603 of this configuration has an outer peripheral surface, other than the rubber portion 61, made of POM. Thus, the transfer of the ink of the banknote to the outer peripheral surface of the feed roller 603 is reduced. Further, since the metal plate 62 is exposed on the outer peripheral surface of the feed roller 603, the abrasion of the resin portion 66 is also reduced.

(Configuration of Compact Storing Unit)

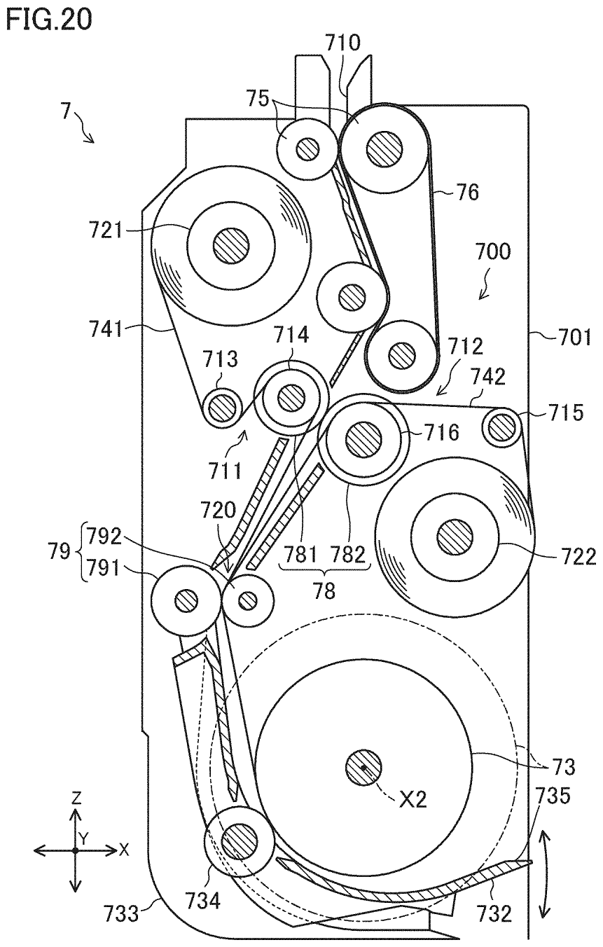

FIGS. 20 to 22 illustrate a configuration of the compact storing unit 36. In the following description, the compact storing unit 36 will be referred to as a storing unit 7.

An outlet/inlet 710 for taking banknotes in and out is provided on an upper surface of the storing unit 7. The outlet/inlet 710 is connected to a lower end of the twelfth transport path 431 of the second lower transport unit 43. The second lower transport unit 43 transports the banknote toward the outlet/inlet 710, and the banknote enters the storing unit 7 through the outlet/inlet 710. Further, the second lower transport unit 43 transports the banknote taken out of the storing unit 7 through the outlet/inlet 710.

The storing unit 7 includes a storing mechanism 700 and a frame 701 accommodating the storing mechanism 700. The storing mechanism 700 winds a banknote on a drum 73 together with tapes sandwiching the banknote therebetween. The banknote is wound onto the drum 73 such that the long edge of the banknote is parallel to the axis of the drum 73. The storing mechanism 700 includes a first reel 721, a second reel 722, and the drum 73.

One end of a first tape 741 is fixed to the first reel 721, and the first tape 741 is wound around the first reel 721. One end of a second tape 742 is fixed to the second reel 722, and the second tape 742 is wound around the second reel 722. The other end of the first tape 741 and the other end of the second tape 742 are fixed to an outer peripheral surface of the drum 73. Two first reels 721 are disposed at a distance from each other in a Y direction that is orthogonal to the paper of FIG. 20. The Y direction corresponds to the right-left direction of the banknote handling apparatus 1. Likewise, two second reels 722 are disposed at a distance from each other in the Y direction.

The first reel 721 rotates in a feeding direction of the first tape 741 and in a winding direction of the first tape 741. The second reel 722 rotates in a feeding direction of the second tape 742 and in a winding direction of the second tape 742. The “feeding direction” refers to a counterclockwise direction in FIG. 20 and the “winding direction” refers to a clockwise direction in FIG. 20.

The drum 73 is disposed in the lower portion of the frame 701. An axis X2 of the drum 73 extends in the Y direction. The axis X2 of the drum 73 is parallel to the axis of the first reel 721 and the axis of the second reel 722. The drum 73 rotates in the winding direction of the banknote and the tapes, and in the feeding direction of the banknote and the tapes. In the example shown in FIG. 20, the direction in which the drum 73 winds the banknote and the tapes thereon is the counterclockwise direction, and the direction in which the drum 73 feeds the banknote and the tapes thereon is the clockwise direction.

The first tape 741 unwound from the first reel 721 runs along a first tape path 711. The first tape path 711 is comprised of a first tape pulley 713 and a second tape pulley 714. The second tape 742 unwound from the second reel 722 runs along a second tape path 712. The second tape path 712 is comprised of a third tape pulley 715 and a fourth tape pulley 716. In a transport path 720, which will be described later, the first tape 741 and the second tape 742 are layered on each other to sandwich the banknote therebetween and are wound around the outer peripheral surface of the drum 73.

The transport path 720 is formed between the outlet/inlet 710 and the drum 73. The transport path 720 is comprised of a roller pair 75, a belt 76, a first grip roller pair 78, and a second grip roller pair 79. The banknote is transported along the transport path 720 in a direction from the outlet/inlet 710 toward the drum 73 or in a direction from the drum 73 toward the outlet/inlet 710.

The roller pair 75 is disposed in the vicinity of the outlet/inlet 710. The roller pair 75 takes the banknote into the storing unit 7 through the outlet/inlet 710 and feeds the banknote out of the storing unit 7 through the outlet/inlet 710.

The belt 76 is wound on two rollers. One of the two rollers serves as the roller pair 75. The belt 76 runs along the transport path 720 of the banknote. The belt 76 transports the banknote from the outlet/inlet 710 to the drum 73 or from the drum 73 to the outlet/inlet 710.

The first grip roller pair 78 is comprised of a first grip roller 781 and a second grip roller 782. The first grip roller 781 and the second grip roller 782 are opposed to each other. The first grip roller 781 is coaxial with the second tape pulley 714. The second grip roller 782 is coaxial with the fourth tape pulley 716.

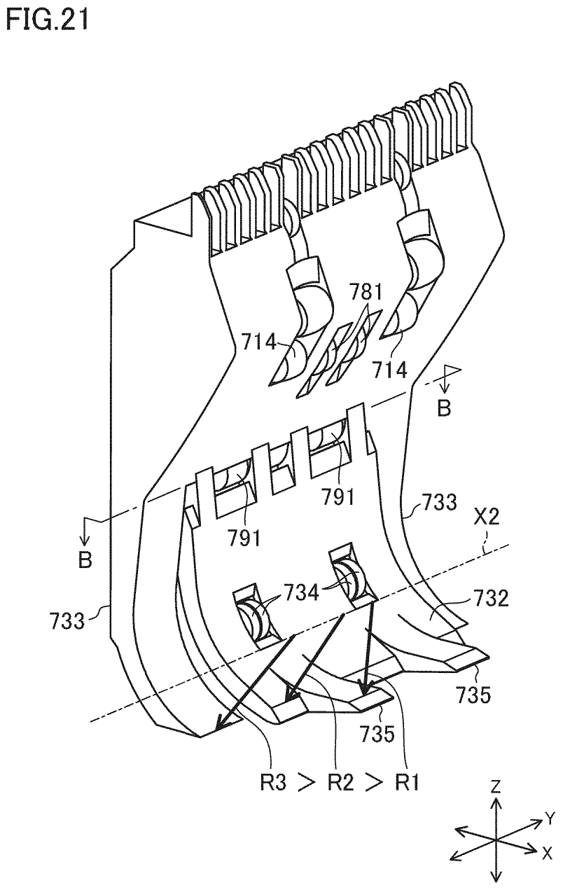

As shown in FIG. 21, two first grip roller pairs 78 are disposed at a distance from each other in the Y direction. FIG. 21 illustrates only the first grip rollers 781 of the first grip roller pairs 78. The rollers of the two first grip roller pairs 78 sandwich a banknote at predetermined positions of the banknote in the longitudinal direction and transport the banknote from the outlet/inlet 710 toward the drum 73 or from the drum 73 toward the outlet/inlet 710.

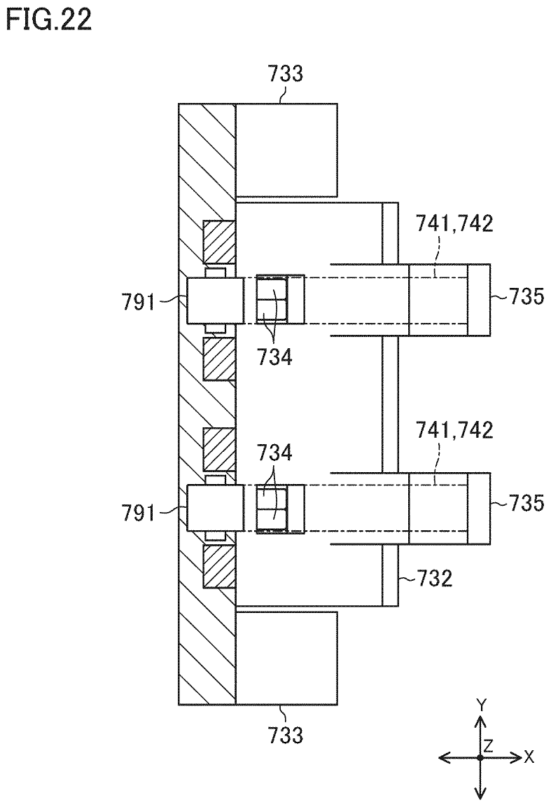

The second grip roller pair 79 is disposed between the first grip roller pair 78 and the drum 73. The second grip roller pair 79 is comprised of a first grip roller 791 and a second grip roller 792. As shown in FIGS. 21 and 22, two second grip roller pairs 79 are disposed at a distance from each other in the Y direction. FIGS. 21 and 22 illustrate only the first grip rollers 791 of the second grip roller pairs 79.

At the second grip roller pair 79, the banknote, the first tape 741, and the second tape 742 are layered on one another. As shown in FIG. 20, the transport path 720 bends at the position of the second grip roller pair 79 in the storing unit 7. Bending of the first tape 741 and the second tape 742 converts part of the tension of the first tape 741 and the second tape 742 into a grip force that causes the first tape 741 and the second tape 742 to sandwich the banknote. In this case, the banknote can be transported without using the first grip roller 791 due to the grip force generated by the first tape 741 and the second tape 742.

Further, since the necessary grip force is reduced in the second grip roller pair 79, the second grip roller pair 79 does not require a driving force for rotating the rollers. The second grip roller pair 79 can be disposed in a position close to the drum 73. This configuration may increase the banknote winding and feeding quality with respect to the drum 73 in the storing unit 7. The storing unit 7 is capable of stably storing banknotes therein and stably feeding the banknotes therefrom.

The storing unit 7 includes a movable guide 732 and a fixed guide 733. The movable guide 732 and the fixed guide 733 guide the banknote, the first tape 741, and the second tape 742 that are wound on the drum 73.

A proximal end of the movable guide 732 is pivotally supported on the fixed guide 733 at a position where the first grip roller 791 of the second grip roller pair 79 is located. The movable guide 732 turns on a rotation center of the first grip roller 791 (see the arrows in FIG. 20). As shown in FIG. 21, the movable guide 732 has a curved shape following the outer peripheral surface of the drum 73.

The movable guide 732 is biased in the counterclockwise direction in FIG. 20 by a biasing member (e.g., a spring). The movable guide 732 is biased in a direction bringing it closer to the drum 73. The movable guide 732 turns in the clockwise direction and in the counterclockwise direction, in accordance with the size of the diameter of the drum 73.

A pressing roller 734 is attached to an intermediate portion of the movable guide 732. The pressing roller 734 presses the first tape 741 and the second tape 742 which are wound around the drum 73.

As shown in FIG. 21, the fixed guide 733 is provided on both lateral sides of the movable guide 732 in the Y direction. The fixed guide 733 has a curved shape, similarly to the movable guide 732. The fixed guide 733 is fixed at a position corresponding to a position where the movable guide 732 turns when the drum 73 has a maximum diameter.

The maximum number of banknotes that can be stored in the storing unit 7 is small. For this reason, a change in the diameter of the drum 73 between a case in which the number of banknotes stored is zero and a case in which the number of banknotes stored is maximum is relatively small. The solid line in FIG. 20 illustrates the diameter of the drum 73 when the number of banknotes stored is zero. The dot-dash line in FIG. 20 illustrates the diameter of the drum 73 when the number of banknotes stored is maximum. Providing the movable guide 732 only at a position corresponding to the center portion of the banknote wound on the drum 73 allows the movable guide 732 to stably guide the banknote, the first tape 741, and the second tape 742 wound on the drum 73 when the number of the banknotes wound on the drum 73 is small. When the number of banknotes wound on the drum 73 increases, the movable guide 732 and the fixed guide 733 can stably guide the banknotes, the first tape 741, and the second tape 742 wound on the drum 73.

Further, the movable guide 732 includes a leading edge guide 735. As shown in FIGS. 21 and 22, the leading edge guide 735 protrudes from the leading edge of the movable guide 732 in a position corresponding to the first tape 741 and the second tape 742. In FIG. 21, distances R1, R2, and R3 are shown. The distance R1 extends from the axis X2 of the drum 73 to the leading edge guide 735; the distance R2 extends from the axis X2 to the movable guide 732; and the distance R3 extends from the axis X2 to the fixed guide 733. The distances R1, R2, and R3 are compared to find that the distance R1 to the leading edge guide 735 is the shortest, that the distance R3 to the fixed guide 733 is the longest, and that the distance R2 to the movable guide 732 is intermediate between the distances R1 and R3.

The banknotes wound on the drum 73 are layered on each other in the radial direction of the drum 73. Since the layered banknotes are pressed to the drum 73 by the first tape 741 and the second tape 742, the diameter of the drum 73 is the smallest at the positions pressed by the first tape 741 and the second tape 742. The banknote is released from the restriction of the first tape 741 and the second tape 742 as it goes away from the positions where the banknote is pressed to the drum 73 by the first tape 741 and the second tape 742 toward the ends of the banknote in the direction of the axis X2 of the drum 73. The diameter of the drum 73 increases in size toward the axial ends of the axis X2.

As described above, the leading edge guide 735, which is positioned at an inner location in the direction along the axis X2, has the shortest distance R1 from the axis X2; and the fixed guide 733, which is positioned at an outer location in the direction along the axis X2, has the longest distance R3 from the axis X2. Each of the leading edge guide 735, the movable guide 732, and the fixed guide 733 is capable of appropriately guiding the banknotes wound on the drum 73 in accordance with the position in the direction along the axis X2. Occurrence of jams due to interference of the banknotes with the movable guide 732 or the fixed guide 733 may be reduced.

(Power Management of Banknote Handling Apparatus)

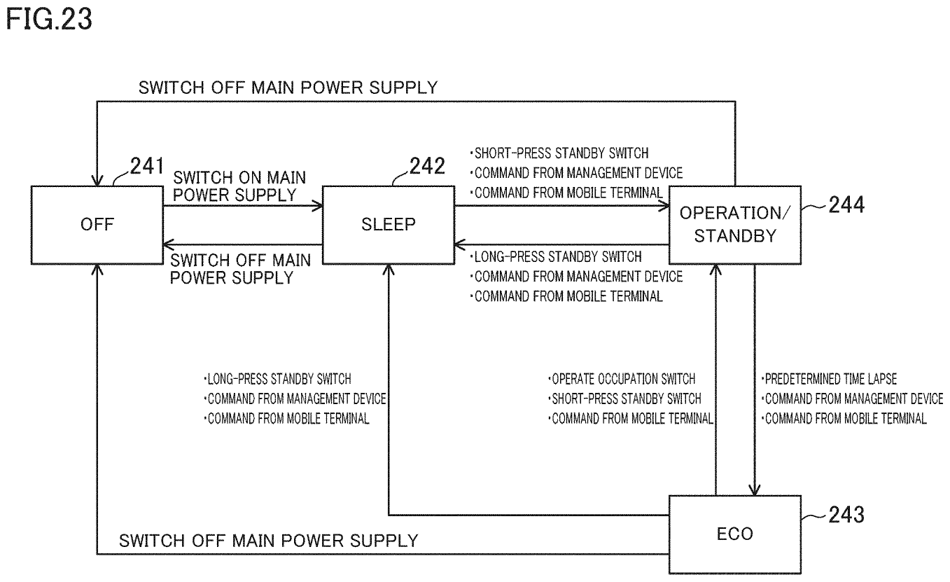

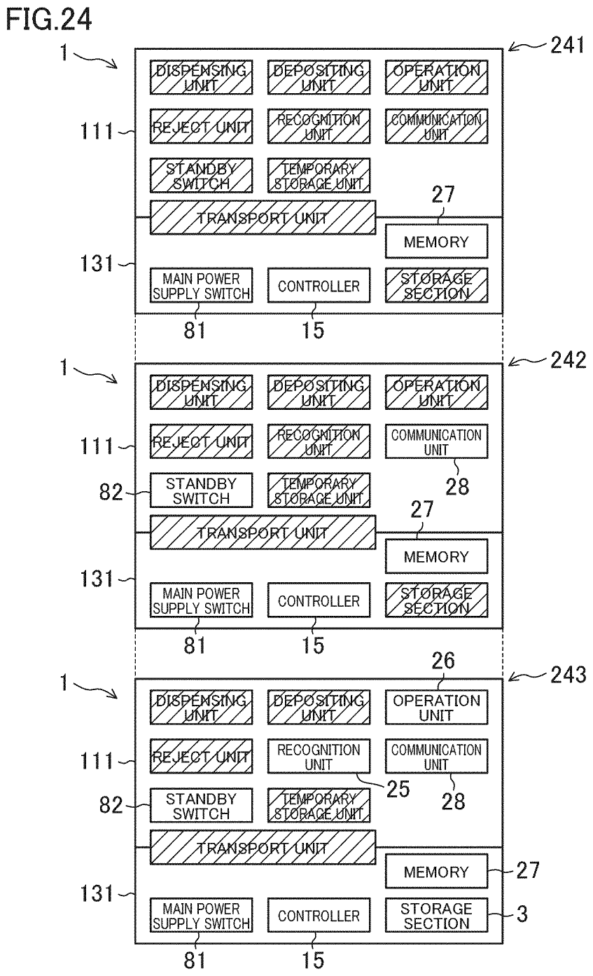

FIG. 23 illustrates a mode shift of the banknote handling apparatus 1. The banknote handling apparatus 1 is capable of shifting among four modes, that is, an off mode 241, an operation/standby mode 244, an eco-mode 243, and a sleep mode 242. FIG. 24 illustrates energization state of each component in the off mode 241 (upper drawing), energization state of each component in the sleep mode 242 (middle drawing), and energization state of each component in the eco mode 243 (lower drawing).

The off mode 241 is a mode in which the main power supply switch 81 is turned off. As shown in FIG. 24, the main power supply switch 81 is provided in the safe housing 131. The operator has to open the door 1310 of the safe housing 131 to operate the main power supply switch 81. The main power supply switch 81 is rarely operated. The banknote handling apparatus 1 is in the off mode 241, for example, during maintenance such as part replacement. As shown in FIG. 23, when the operator turns the main power supply switch 81 off in each of the operation/standby mode 244, the eco mode 243, and the sleep mode 242, the banknote handling apparatus 1 shifts to the off mode 241. As shown in the upper drawing of FIG. 24, when the banknote handling apparatus 1 is in the off mode 241, power is supplied only to the controller 15 and the memory 27.

If the operator turns the main power supply switch 81 on in the off mode 241, the banknote handling apparatus 1 shifts to the sleep mode 242. When the banknote handling apparatus 1 is in the sleep mode 242, power is supplied to the controller 15, the memory 27, and the communication unit 28, as shown in the middle drawing in FIG. 24. The banknote handling apparatus 1 is shifted to the sleep mode 242 outside the bank's working hours, for example, at night or during holiday. In the sleep mode 242, power is supplied to minimal components, which allows the banknote handling apparatus 1 to save the electric power. The banknote handling apparatus 1 shifts to the operation/standby mode 244 when in the sleep mode 242 the operator short-presses a standby switch 82, or when in the sleep mode 242 a command to shift to the operation/standby mode is input from the management device 201, or when in the sleep mode 242 a command to shift to the operation/standby mode is input from the mobile terminal 202. The banknote handling apparatus 1 may shift from the sleep mode to the operation/standby mode by remote control. As shown in FIG. 24, the standby switch 82 is provided in the upper housing 111. The standby switch 82 is provided in a position where it is easy for the operator to operate the standby switch 82.

Power is supplied to all components when the banknote handling apparatus 1 is in the operation/standby mode 244. The banknote handling apparatus 1 is capable of executing various processes. The banknote handling apparatus 1 is shifted to the operation/standby mode 244 during the bank's working hours. The banknote handling apparatus 1 shifts to the sleep mode 242 when in the operation/standby mode 244 the operator long-presses the standby switch 82, or when in the operation/standby mode 244 a command to shift to the sleep mode is input from the management device 201, or when in the operation/standby mode 244 a command to shift to the sleep mode is input from the mobile terminal 202. If no operation is made for a certain period of time in the operation/standby mode, the banknote handling apparatus 1 shifts to the eco mode 243 when a command to shift to the eco mode 243 is input from the management device 201 or when a command to shift to the eco mode 243 is input from the mobile terminal 202.

When the banknote handling apparatus 1 is in the eco mode 243, power is supplied to the controller 15, the memory 27, the communication unit 28, the operation unit 26, the recognition unit 25, and the storage section 3, as shown in the lower drawing in FIG. 24. That is, power is supplied to the components other than driving portions in the banknote handling apparatus 1. This configuration achieves prompt shift from the eco mode 243 to the operation/standby mode 244. At the same time, it is possible to reduce the power consumption of the banknote handling apparatus 1. The banknote handling apparatus 1 shifts to the eco mode 243 when the banknote handling apparatus 1 is not used during the bank's working hours. The banknote handling apparatus 1 shifts to the operation/standby mode 244 when in the eco mode 243 the operator operates the occupation switch 261 or short-presses the standby switch 82, or when in the eco mode 243 a command to shift to the operation/standby mode 244 is input from the mobile terminal 202. The banknote handling apparatus 1 shifts to the sleep mode 242 when in the eco mode 243 the operator long-presses the standby switch 82, or when in the eco mode 243 a command to shift to the sleep mode is input from the management device 201, or when in the eco mode 243 a command to shift to the sleep mode is input from the mobile terminal 202.

(Other Example Configurations of Banknote Handling Apparatus)

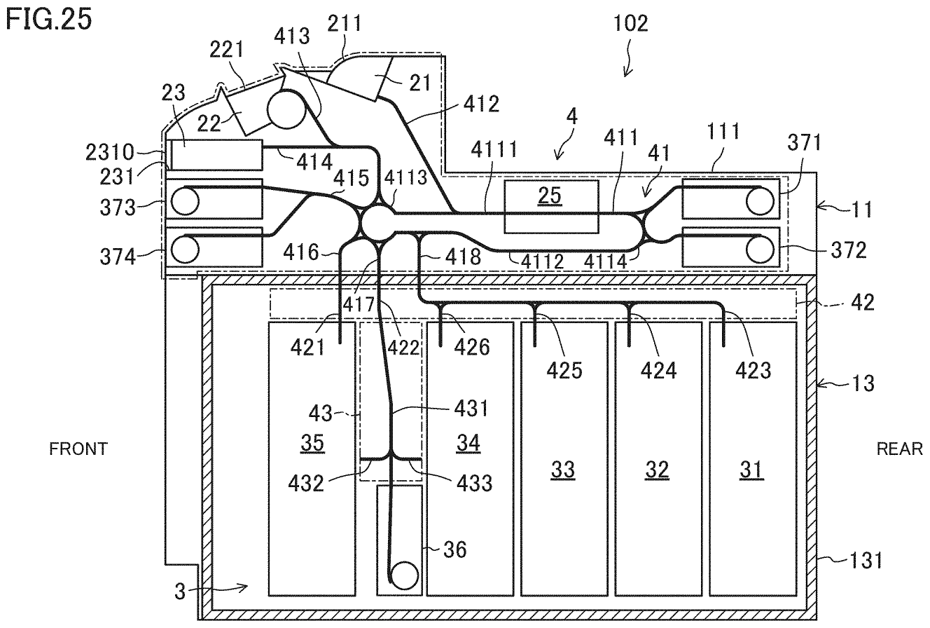

FIG. 25 illustrates a banknote handling apparatus 102 according to a variation. The banknote handling apparatus 102 includes compact storing units 371 and 372 in the rear portion of the upper housing 111. In the example configuration of FIG. 25, the banknote handling apparatus 102 includes two compact storing units 371 and 372. Each of the first compact storing unit 371 and the second compact storing unit 372 is connected to the rear curved portion 4114 of the first transport path 411.

Each of the first compact storing unit 371 and the second compact storing unit 372 may have the same configuration as the compact storing unit 36. Each of the first compact storing unit 371 and the second compact storing unit 372 may be a tape-winding storing unit. Such first and second compact storing units 371 and 372 may store counterfeit notes or banknotes that are suspected to be counterfeit notes. The provision of the first and second compact storing units 371 and 372 increases the number of storing units in the banknote handling apparatus 1, which improves the usability of the banknote handling apparatus 1. Further, the first compact storing unit 371 and the second compact storing unit 372, if being the tape-winding storing units, are capable of feeding the stored banknotes, as necessary. The first compact storing unit 371 and the second compact storing unit 372 may be used for the purpose of storing the banknotes temporarily. The banknote handling apparatus 102 may include any one of the first compact storing unit 371 or the second compact storing unit 372 as the compact storing unit.

The banknote handling apparatus 102 includes two compact storing units 373 and 374 instead of the temporary storage unit 24. The third compact storing unit 373 and the fourth compact storing unit 374 are arranged one above the other at a position under the reject unit 23 in the front portion of the upper housing 111. The third compact storing unit 373 and the fourth compact storing unit 374 are connected to the front curved portion 4113 of the first transport path 411 via the fifth transport path 415. In this example configuration, the fifth transport path 415 diverges into two branches.

The third compact storing unit 373 and the fourth compact storing unit 374 may be used as, for example, a plurality of temporary storage units. A plurality of temporary storage units make it possible that, even if a failure occurs in one of the compact storing units, the banknote handling apparatus 102 may continue the process using the other compact storing unit. The plurality of temporary storage units can be used differently, depending on the types of banknotes.

In the banknote handling apparatus 102, the compact storing units 36, 371, 372, 373, and 374 are arranged in the upper housing 111 and in the safe housing 131. Using these compact storing units 36, 371, 372, 373, and 374 differently makes it possible that the banknote handling apparatus 102 executes various processes. This improves the usability of the banknote handling apparatus 102.

The banknote handling apparatus may include only one or only some of the first, second, third, and fourth compact storing units 371, 372, 373, and 374 shown in FIG. 25.

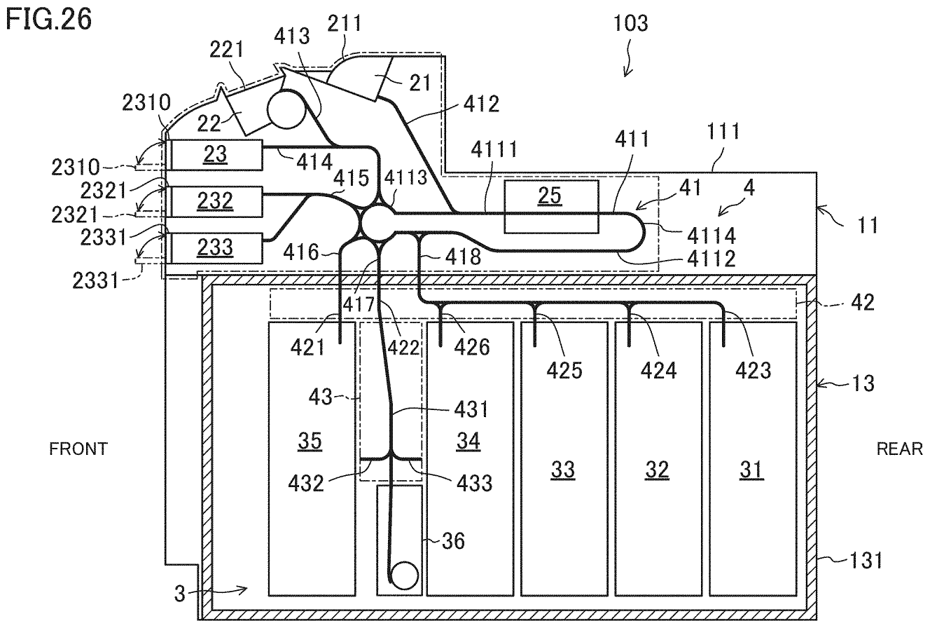

FIG. 26 illustrates a banknote handling apparatus 103 according to another variation. The banknote handling apparatus 103 includes two stacking units 232 and 233 in the front portion of the upper housing 111, instead of the temporary storage unit 24. Each of the two stacking units 232 and 233 has the same configuration as the reject unit 23. Each of the stacking units 232 and 233 keeps a plurality of banknotes stacked on top of one another. In the example configuration of FIG. 26, the two stacking units 232 and 233 have shutters 2321 and 2331, respectively. The shutters 2321 and 2331, similarly to the shutter 2310, may be opened to the outside of the banknote handling apparatus 103 (see the two-dot chain line in FIG. 26). When the shutters 2321 and 2331 are open, the operator is able to take out the banknotes stacked in the stacking units 232 and 233. Using the plurality of stacking units 232 and 233 and the reject unit 23, the banknote handling apparatus 103 is capable of executing various processes.

The shutters may not be provided at the stacking units 232 and 233. Alternatively, a shutter may be provided only to some of the stacking units. A stacking unit may be provided in the rear portion of the upper housing 111.

FIG. 27 illustrates a block diagram of a computer that may implement the various embodiments of the controller 15, as described herein. The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 27 is a functional block diagram illustrating a networked system 800 of one or more networked computers and servers, any one of which, or combinations of which may be the controller 15. In an embodiment, the hardware and software environment illustrated in FIG. 27 may provide an exemplary platform for implementation of the software and/or methods according to the present disclosure. Referring to FIG. 27, a networked system 800 may include, but is not limited to, computer 805, network 810, remote computer 815, web server 820, cloud storage server 825 and computer server 830. In some embodiments, multiple instances of one or more of the functional blocks illustrated in FIG. 27 may be employed.

Additional detail of computer 805 is shown in FIG. 27. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805. Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium. Core i3, Core i5 and Core i7 from Intel Corporation; Opteron. Phenom, Athlon, Turion and Ryzen from AMD, and Cortex-A, Cortex-R and Cortex-M from Arm. Bus 837 may be a proprietary or industry standard high-speed parallel or serial peripheral interconnect bus, such as ISA, PCI, PCI Express (PCI-e), AGP, and the like. Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage, and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

An apparatus in accordance with the present application will improve the transport of sheets in the curved portion.

According to this configuration, the curved portion has a small number of parts. Further, since the inner peripheral portion of the curved portion rotates, jamming of sheets is less likely to occur. The transportation of the sheets in the curved portion is improved. At least one first branch may be connected to the curved portion, and a diverter for changing a transport direction of the sheet may be provided at a junction where the first branch is connected. In accordance with the present application, jamming of sheets is less likely to occur in the curved portion even with a diverter.

In accordance with the present application, when the sheet is transported in the forward direction along the transport path, the diverter may selectively change the transport direction of the sheet to any one of three directions including: a first forward direction in which the sheet is transported from the transport path toward the first branch; a second forward direction in which the sheet is transported from the first branch toward the transport path; and a third forward direction in which the sheet is transported along the transport path.

In accordance with the present application, when the sheet is transported in the backward direction along the transport path, the diverter may selectively change the transport direction of the sheet to any one of three directions including: a first backward direction in which the sheet is transported from the transport path toward the first branch; a second backward direction in which the sheet is transported from the first branch toward the transport path; and a third backward direction in which the sheet is transported along the transport path.

In accordance with the present application, jamming of sheets is less likely to occur in the curved portion even with a three-way diverter. The first branch may be connected to a first storage for storing the sheet. The sheet is stably transported from the curved portion to the first storing unit. The first storage may be divided into an upper storage and a lower storage, and

The first branch may include at least one of a branch connected to the upper storage or a branch connected to the lower storage. The sheet is stably transported from the curved portion to each of the upper storage and the lower storage.

In accordance with the present application, the first branch may include at least one of a branch connected to a temporary storage which keeps the sheet in a manner that allows the sheet to be stored and fed, a branch connected to a dispenser that dispenses the sheet to an outside of the sheet handling apparatus, or a branch connected to an upper storage for storing the sheet. The sheet is stably transported from the curved portion to the temporary storage, the dispensing unit, or the first storing unit.

In accordance with the present application, at least one second branch may be connected to the second path, and a diverter for changing the transport direction of the sheet may be provided at a junction where the second branch is connected. The sheet is transported from the second path to the second branch and from the second branch to the second path. The second branch may be connected to a second storage for storing the sheet. The sheet is transported from the second path to the second storing unit and from the second storing unit to the second path.

In accordance with the present application, the sheet handling apparatus may further include a recognizer that is disposed in the first path and recognizes the sheet, wherein the diverter may change the transport direction of the sheet based on a recognition result of the recognizer. The sheet recognized by the recognition unit is transported to a predetermined destination by the diverter. The first path and the second path may include a first transport roller for transporting the sheet, and the first transport roller may have a diameter smaller than a diameter of the rolling body.

In accordance with the present application, the first transport roller rotates at a rotational speed higher than a rotational speed of the rolling body. The sheet is transported at a constant speed in the transport path. The rotational speed of the rolling body and the rotational speed of the first transport roller may be changed based on a recognition result of the recognition unit. When the rotational speed of the rolling body and the rotational speed of the first transport roller are changed, the transport speed of the sheet changes.

In accordance with the present application, the sheet handling apparatus may further include a detector that is provided in the transport path and detects the sheet, and a controller that controls the diverter based on a detection result of the detector. The controller controls the diverter in accordance with a position of the sheet being transported. The sheet is sent from the transport path to a predetermined destination. The rolling body may be a second transport roller that transports the sheet with the sheet being sandwiched between a circumferential surface of the rolling body and each of the rollers. The curved portion of this configuration has even smaller number of parts. The rolling body may be a pulley having a circumferential surface on which a belt is wound, and the sheet may be transported while being sandwiched between the belt and each of the rollers. In accordance with the present application, using the belt reduces jamming of sheets in the curved portion.

1. A sheet handling apparatus, comprising:
a transport path that includes a first path, a second path, and a curved portion connecting the first path and the second path, the transport path circularly transports a sheet along the transport path in a forward direction or a backward direction;
a rolling body that is disposed at the curved portion and rotates clockwise and counterclockwise; and
a plurality of rollers that are opposed to the rolling body and sandwich the sheet between rollers of the plurality of rollers and the rolling body along the curved portion of the transport path, wherein
the rolling body transports the sheet in the forward direction by rotating clockwise and transports the sheet in the backward direction by rotating counterclockwise.

2. The sheet handling apparatus of claim 1, further comprising:
at least one first branch connected to the curved portion; and
a diverter changing a transport direction of the sheet, the diverter being provided at a first junction where the first branch is connected.

3. The sheet handling apparatus of claim 2, wherein when the sheet is transported in the forward direction along the transport path, the diverter changes the transport direction of the sheet to any one of three directions including:
a first forward direction in which the sheet is transported from the transport path toward the first branch;
a second forward direction in which the sheet is transported from the first branch toward the transport path; and
a third forward direction in which the sheet is transported along the transport path.

4. The sheet handling apparatus of claim 2, wherein when the sheet is transported in the backward direction along the transport path, the diverter changes the transport direction of the sheet to any one of three directions including:
a first backward direction in which the sheet is transported from the transport path toward the first branch;
a second backward direction in which the sheet is transported from the first branch toward the transport path; and
a third backward direction in which the sheet is transported along the transport path.

5. The sheet handling apparatus of claim 2, wherein the first branch is connected to a first storage for storing the sheet.

6. The sheet handling apparatus of claim 5, wherein
the first storage is divided into an upper storage and a lower storage, and
the first branch includes at least one of a second branch connected to the upper storage or a third branch connected to the lower storage.

7. The sheet handling apparatus of claim 2, wherein the first branch includes at least one of:
a second branch connected to a temporary storage which holds the sheet so that the sheet is stored and fed,
a third branch connected to a dispenser that dispenses the sheet to an outside of the sheet handling apparatus, or
a fourth branch connected to an upper storage for storing the sheet.

8. The sheet handling apparatus of claim 2, wherein
at least one second branch is connected to the second path, and
the diverter is provided at a second junction where the second branch is connected.

9. The sheet handling apparatus of claim 8, wherein the second branch is connected to a second storage for storing the sheet.

10. The sheet handling apparatus of claim 2, further comprising:
a recognition sensor that is disposed at the first path and recognizes the sheet, wherein
the diverter changes the transport direction of the sheet based on a recognition result of the recognition sensor.

11. The sheet handling apparatus of claim 10, wherein
the first path and the second path include a first transport roller for transporting the sheet, and
the first transport roller has a diameter smaller than a diameter of the rolling body.

12. The sheet handling apparatus of claim 2, further comprising:
a sensor that is disposed at the transport path and detects the sheet, and
a processing circuitry that controls the diverter based on a detection result of the sensor.

13. The sheet handling apparatus of claim 1, wherein the rolling body is a transport roller that transports the sheet as the sheet is sandwiched between a circumferential surface of the rolling body and rollers of the plurality of rollers.

14. The sheet handling apparatus of claim 1, wherein
the rolling body is a pulley having a circumferential surface on which a belt is wound, and
the sheet is transported while sandwiched between the belt and rollers of the plurality of rollers.

15. The sheet handling apparatus of claim 1, further comprising processing circuitry configured to control the rolling body to rotate clockwise or counterclockwise.

16. The sheet handling apparatus of claim 15, further comprising:
a diverter provided at a junction between the curved portion and a first branch that branches from the curved portion, wherein
the processing circuitry is further configured to control the diverter to change a transport direction of the sheet.

17. The sheet handling apparatus of claim 1, wherein the rolling body is a pulley or a roller.

18. A sheet handling apparatus, comprising:
a transport path that includes a curved portion and circularly transports a sheet in a forward direction or a backward direction;
a rolling body that is disposed at the curved portion and rotates clockwise and counterclockwise; and
a plurality of rollers that are opposed to the rolling body and sandwich the sheet between rollers of the plurality of rollers and the rolling body along the curved portion of the transport path; and
processing circuitry configured to control the rolling body to rotate clockwise or counterclockwise, wherein
the rolling body transports the sheet in the forward direction by rotating clockwise and transports the sheet in the backward direction by rotating counterclockwise.

19. The sheet handling apparatus of claim 18, further comprising:
a diverter provided at a junction between the curved portion and a first branch that branches from the curved portion, wherein
the processing circuitry is further configured to control the diverter to change a transport direction of the sheet.

20. A sheet handling apparatus, comprising:
a transport path that includes a first path, a second path, and a curved portion connecting the first path and the second path, the transport path circularly transports a sheet along the transport path in a forward direction or a backward direction;
rolling means that is disposed at the curved portion and rotates clockwise and counterclockwise; and
a plurality of rollers that are opposed to the rolling means and sandwich the sheet between each of the plurality of rollers and the rolling means along the curved portion of the transport path, wherein
the rolling means transports the sheet in the forward direction by rotating clockwise and transports the sheet in the backward direction by rotating counterclockwise.
